(19) United States
(12) Patent Application Publication
(10) Pub. No.: US 2019/0097900 A1
(43) Pub. Date: Mar. 28, 2019

(54) ZERO-CONFIGURATION CLUSTER AND PROVISIONING PIPELINE FOR HETEROGENEOUS COMPUTING NODES

(71) Applicants: Bryan J. Rodriguez, Gilbert, AZ (US); Jacob L.E. Blain Christen, Chandler, AZ (US); Michael G. Millsap, Gilbert, AZ (US)

(72) Inventors: Bryan J. Rodriguez, Gilbert, AZ (US); Jacob L.E. Blain Christen, Chandler, AZ (US); Michael G. Millsap, Gilbert, AZ (US)

(21) Appl. No.: 16/200,364

(22) Filed: Nov. 26, 2018

(51) Int. Cl. H04L 12/24; G06F 9/50; G06F 9/455; G06F 16/176; G06F 16/182; G06F 16/27; G06F 11/30

(52) U.S. Cl. CPC H04L 41/5054; G06F 9/5011; G06F 9/5072; G06F 9/45558; H04L 41/0806; H04L 41/0816; H04L 67/10; H04L 41/12; G06F 16/176; G06F 16/184; G06F 16/27; G06F 11/3051; H04L 41/509

(57) ABSTRACT

In one embodiment, an apparatus comprises a network interface to communicate over a local network, a storage drive, and a processor. The processor is to: connect to the local network via the network interface; detect a plurality of heterogeneous edge computing nodes on the local network; join a cluster of computing nodes on the local network; configure the storage drive to join a shared file system associated with the cluster; configure one or more local hardware resources to join a pool of shared hardware resources associated with the cluster; obtain a plurality of container images for an application configured to execute on the cluster, wherein the plurality of container images are for executing a plurality of containers associated with the application; and execute one or more of the plurality of containers associated with the application.

### FIELD OF THE SPECIFICATION

This disclosure relates in general to the field of distributed computing, and more particularly, though not exclusively, to a zero-configuration cluster and provisioning pipeline for heterogeneous computing nodes.

### BACKGROUND

Deploying, configuring, and scaling a cluster of heterogeneous computing nodes can be challenging, as existing solutions are unable to automatically adapt to different types of computing hardware on-the-fly, thus requiring many time-consuming and tedious tasks to be performed manually. Existing solutions also suffer from various performance drawbacks. For example, existing solutions are typically required to run on top of hypervisors rather than bare-metal, which increases processing overhead, and they typically depend on separate storage networks for data storage, thus increasing data access latency.

Developing and provisioning software for heterogeneous computing nodes can also be challenging. For example, existing provisioning solutions typically require pre-built software images to be compiled and built in advance for each type of computing node that the software will be provisioned on, which can be time consuming and tedious. Moreover, these images typically have to be completely rebuilt in order to accommodate any hardware changes.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example computing system for provisioning and deploying a cluster of heterogeneous computing nodes in accordance with the embodiments described throughout this disclosure.

FIG. 2 illustrates an example embodiment of a node for a zero-configuration cluster.

FIGS. 3A-D illustrate an example of the operation of a zero-configuration cluster.

FIG. 4 illustrates a flowchart for an example embodiment of a node for a zero-configuration cluster.

FIG. 5 illustrates an example computing system with a CI/CD provisioning pipeline for heterogeneous computing nodes.

FIG. 6 illustrates an example of the provisioning process from system integrator to customer.

FIG. 7 illustrates an example embodiment of an edge provisioner.

FIGS. 8, 9, 10, and 11 illustrate examples of Internet-of-Things (IoT) networks and architectures that can be used in accordance with certain embodiments.

FIGS. 12 and 13 illustrate example computer architectures that can be used in accordance with certain embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

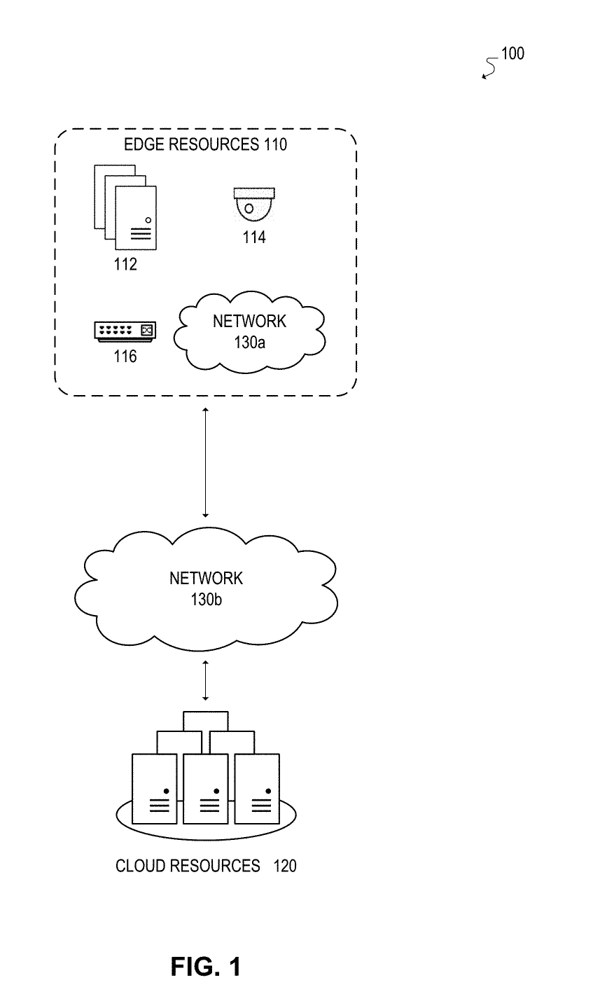

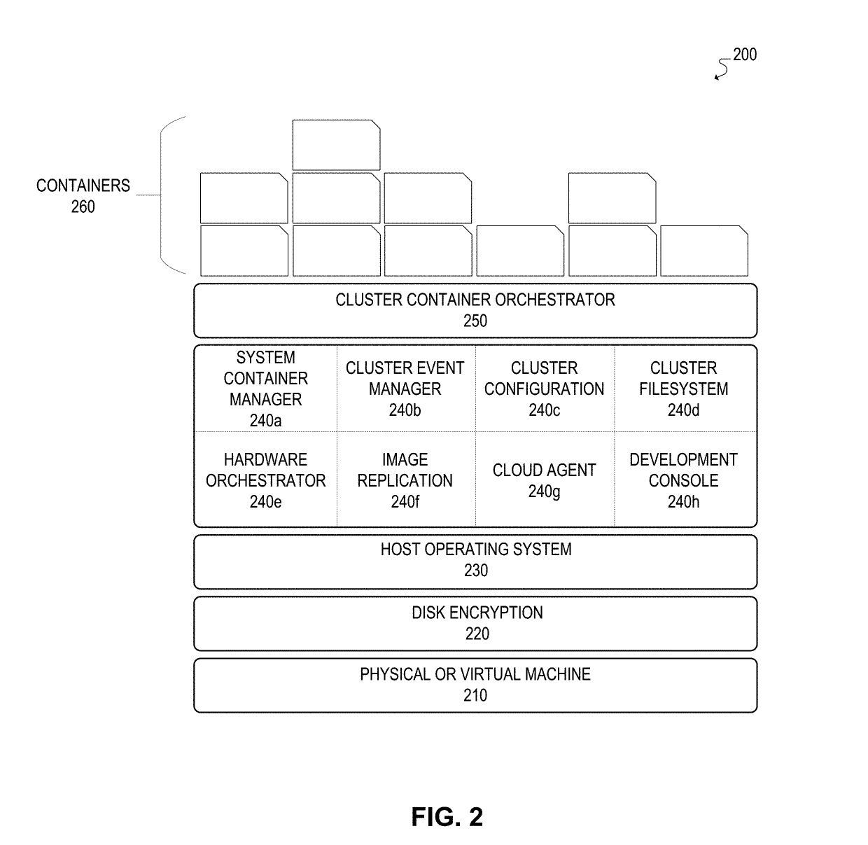

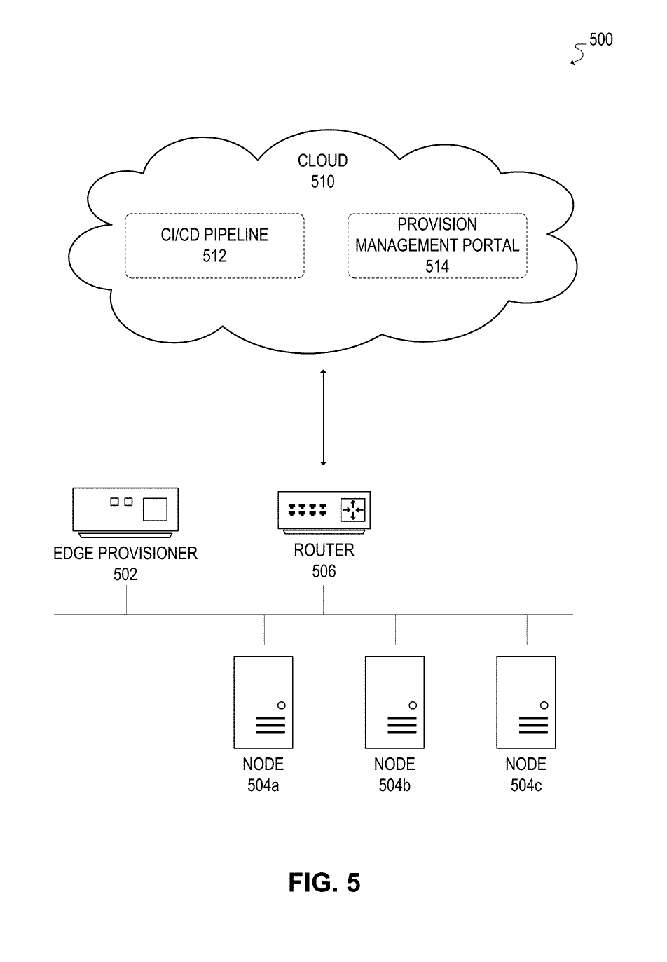

FIG. 1 illustrates an example computing system 100 for provisioning and/or deploying a cluster of heterogeneous computing nodes in accordance with the embodiments described throughout this disclosure. For example, this disclosure presents embodiments for deploying a zero-configuration cluster of heterogeneous computing nodes (e.g., as described in connection with FIGS. 2-4), as well as embodiments for dynamically provisioning the heterogeneous computing nodes from a continuous integration and continuously delivery (CI/CD) pipeline (e.g., as described in connection with FIGS. 5-7). Accordingly, in some embodiments, the functionality described throughout this disclosure may be implemented within computing system 100.

In the illustrated example, computing system 100 includes a variety of edge resources 110, cloud resources 120, and communication network(s) 130a-b, as described further below.

The edge resources 110 may include any type of devices or resources deployed at or near the edge of a communication network, such as on a local area network 130a. In some cases, for example, the edge resources 110 may be deployed on the premises of an end-user or business (e.g., a retail store), a manufacturing vendor, ora software/hardware developer, among other examples. In the illustrated example, the edge resources 110 include one or more computing nodes 112, sensors 114, and routers 116, among other possible devices.

Computing nodes 112 may include a variety of computing devices that are deployed in a particular environment (e.g., an edge computing environment), such as on-premise servers, computing appliances, personal computers, and so forth. Moreover, in some cases, computing nodes 112 may be heterogeneous machines implemented with a variety of different hardware configurations, including both bare-metal machines and virtual machines. In some embodiments, for example, computing nodes 112 may be developed, provisioned, and/or deployed to form a zero-configuration cluster of heterogeneous computing nodes (e.g., as described in connection with FIGS. 2-4). Moreover, in some embodiments, computing nodes 112 may include an edge provisioning node that is used to dynamically provision software from a CI/CD pipeline onto the other computing nodes 112 on the local network (e.g., as described in connection with FIGS. 5-7).

Sensors 114 may include any type of devices capable of capturing or detecting information associated with a surrounding environment, including cameras and other vision sensors, microphones, motion sensors, RFID readers and antennas, and so forth. In some embodiments, for example, sensors 114 may be deployed on the premises of a brick-and-mortar facility, such as a retail store.

Router 116 may include any type of device that facilitates communication over one or more networks 130a-b, such as a local area network (LAN) 130a that enables the edge resources 110 to communicate among each other, and/or a wide area network (WAN) 130b that enables the edge resources 110 to communicate with other external resources, such as cloud-based resources 120.

Cloud computing resources 120 may include any resources or services that are hosted remotely over a network, which may otherwise be referred to as in the “cloud.” In some embodiments, for example, cloud resources 120 may be remotely hosted on servers in a datacenter (e.g., application servers, database servers). In general, cloud resources 120 may include any resources, services, and/or functionality that can be utilized by or for components of computing system 100, such as edge resources 110. In some embodiments, for example, cloud resources 120 may include a cluster development, configuration, and/or provisioning service.

Communication network(s) 130 may be used to facilitate communication between components of computing system 100, such as between edge 110 and cloud 120 resources. In various embodiments, computing system 100 may be implemented using any number or type of communication network(s) 130, including local area networks, wide area networks, public networks, the Internet, cellular networks, Wi-Fi networks, short-range networks (e.g., Bluetooth or ZigBee), and/or any other wired or wireless communication networks or mediums.

Any, all, or some of the computing devices of computing system 100 may be adapted to execute any operating system, including Linux or other UNIX-based operating systems, Microsoft Windows, Windows Server, MacOS, Apple iOS, Google Android, or any customized and/or proprietary operating system, along with virtual machines adapted to virtualize execution of a particular operating system.

While FIG. 1 is described as containing or being associated with a plurality of elements, not all elements illustrated within computing system 100 of FIG. 1 may be utilized in each alternative implementation of the present disclosure. Additionally, one or more of the elements described in connection with the examples of FIG. 1 may be located external to computing system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments associated with the implementation of computing system 100 are described further in connection with the remaining FIGURES. Accordingly, it should be appreciated that computing system 100 of FIG. 1 may be implemented with any aspects of the embodiments described throughout this disclosure.

Zero-Configuration Cluster

Deploying, configuring, and scaling a cluster of heterogeneous computing nodes (e.g., on a local edge network) can be challenging, as existing solutions suffer from various drawbacks. For example, existing solutions lack a zero-configuration architecture, a complete provisioning pipeline, and the ability to scale seamlessly on commodity hardware. Accordingly, managing a cluster of heterogeneous computing nodes using existing solutions typically requires many time-consuming and tedious tasks to be performed manually. Existing solutions also suffer from various performance drawbacks. For example, many cluster solutions start with hypervisors and storage area network (SAN) abstractions on larger physical footprints that usually reside in data center environments. These solutions are further away from bare-metal, and consequently, they are slower and more expensive to operate. Moreover, these solutions typically lack persisted disk volumes across each node, which introduces additional latency for disk input/output (I/O).

Accordingly, this disclosure presents various embodiments of a zero-configuration cluster of heterogeneous computing nodes. The described embodiments provide the ability to scale horizontally on commodity to enterprise computing hardware (e.g., Intel x86 hardware) with zero configuration using a container-driven hyperconverged infrastructure, while also abstracting application development from scaling application workloads. For example, a new node can be added to an existing cluster—or become the first node of a new cluster—by simply connecting it to the local network and powering it on. In this manner, the hyperconverged zero-configuration architecture eliminates the configuration headache associating with configuring and managing a cluster of heterogeneous computing nodes. The zero-configuration architecture also provides intelligent workload orchestration with support for distributed workloads and workload affinity for specific types of hardware. In addition, the zero-configuration architecture provides high availability and enables hardware upgrades with no downtime. Further, every hardware resource of every physical node in the cluster (e.g., USB ports, HDMI display ports, storage drives) becomes an available resource that can be used by any application workload, regardless of which physical node(s) the workload is executing on. In particular, the described architecture provides persisted disk storage across all nodes in the cluster.

This technology can be leveraged in any industry, including retail, autonomous vehicles, industrial, and so forth. For example, this technology simplifies deployment and installation of edge compute environments regardless of whether they reside inside retail stores, vehicles, datacenters, or elsewhere. Further, this technology can be used on bare-metal to the cloud infrastructures or mixed virtual machine (VM) and bare-metal infrastructures.

FIG. 2 illustrates an example embodiment of a node 200 for a zero-configuration cluster. In the illustrated embodiment, for example, a node 200 for a zero-configuration cluster is implemented on a bare-metal or virtual machine in a container-driven infrastructure, as described further below.

Scaling a node vertically (e.g., incorporating additional hardware resources into an existing node) has various drawbacks, including high costs, limited flexibility, and a single point of failure. In the illustrated embodiment, however, node 200 enables heterogeneous computing nodes to be scaled horizontally with zero configuration, which allows a cluster to be initially created using node(s) implemented on commodity hardware and subsequently scaled as needed by simply adding additional nodes. For example, as application workloads demand more resources, additional physical nodes (e.g., heterogeneous Intel x86 computing nodes) can be added to the existing infrastructure to form a heterogeneous cluster using a “Lego building block” type approach. Simply plug a new physical machine into the network and walk away—the new machine will auto-configure itself, join the existing cluster (or form a new cluster), and become an available resource for the various application workloads.

This zero-configuration architecture provides high availability, distributed workloads, workload affinity to specific hardware, hardware upgrades with 24/7 uptime, and autonomous healing (e.g., workload migration across physical nodes in the event of a node failure), among other benefits. For example, applications for a variety of different operating systems (e.g., Linux, Windows, and Android) can run simultaneously in the same compute environment across a heterogeneous infrastructure of computing nodes (e.g., Intel x86 nodes from Celeron to Xeon and/or nodes of other processor architectures). Further, every hardware resource of every physical node in the cluster—including peripheral device ports such as USB ports and HDMI display ports—becomes an available resource for any application workload to make use of, regardless of which physical node(s) the particular workload is executing on. For example, a USB camera may be plugged into one physical node (e.g., an Intel Celeron node) while another physical node with a GPU accelerator (e.g., an Intel Core i7 node) executes a computer vision workload that consumes the video feed from the USB camera (e.g., an OpenVino workload). Similarly, the video output from an Android application running on one node (e.g., an Intel Xeon node) can be displayed by a separate node (e.g., an Intel Celeron node) with an attached HDMI display screen. Files can be written to the storage drive of one node and immediately accessed on the storage drive of another node using a real-time file system. Workloads can be scheduled on a real-time operating system (RTOS) in the same heterogeneous compute environment. Moreover, all of this functionality can be remotely managed and deployed through a cloud-based operating environment.

FIG. 2 illustrates an example technology stack for a node 200 of a zero-configuration heterogeneous cluster. In the illustrated embodiment, the technology stack of node 200 includes (from bottom to top) a physical or virtual machine 210, a disk encryption layer 220, a host operating system 230, a layer of cluster system services 240a-h, a cluster container orchestrator 250, and a layer of containers 260. In some embodiments, additional logic may also be included to “glue” these respective components together, such as scripts written in BASH and/or the Go programming language (Golang). Further, the entire software stack other than the application-level containers 260 is pre-provisioned on node 200 (e.g., a bare-metal or virtual machine) before the node is deployed on a network, and the remaining containers 260 are subsequently provisioned after the node 200 is deployed since they will vary for different applications and use cases. For example, in some embodiments, node 200 may be provisioned in the manner described further in connection with FIGS. 5-7.

In the illustrated embodiment, node 200 can be implemented on either a physical or virtual machine (VM) 210, with a host operating system 230 on top of the machine (e.g., a Linux distribution such as RancherOS), and optionally a disk encryption mechanism 220 for data protection. Various cluster system services 240a-h are used to perform functions relating to cluster and/or system management, as described further below. Moreover, the user-level container orchestrator 250 manages a collection of containers 260 that are used to execute the various application workloads, and further handles container and network orchestration across the nodes of the cluster. For example, container orchestrator 250 orchestrates and schedules the containers 260 across a cluster of nodes that are treated as a single virtual system. In some embodiments, for example, container orchestrator 250 may be implemented using Docker Swarm, Kubernetes, HashiCorp Nomad, and/or any other suitable orchestration service.

Cluster system services 240a-h are used to perform various functions for node 200 relating to cluster management, including automatically configuring, joining, and participating in an associated cluster of heterogeneous computing nodes, among other examples. In the illustrated embodiment, for example, cluster system services 240a-h include a system container manager 240a, a cluster event manager 240b, a cluster configuration service 240c, a cluster filesystem service 240d, a dynamic hardware orchestrator (DHO) 240e, a container image replication service 240f, a cloud agent 240g, and a development console 240h.

System container manager 240a (e.g., System Docker) is used for managing system-level containers.

Cluster event manager 240b is an event-driven service that detects and processes cluster-related events, such as initial system/cluster discovery, cluster membership changes, node failures, and so forth. In some embodiments, for example, cluster event manager 240b may detect cluster-related events and trigger the appropriate logical code or scripts for handling the detected events. For example, when node 200 initially powers on and boots up, cluster event manager 240b may perform initial discovery of potential nodes and/or services that already exist on the local network (e.g., using multicast DNS (mDNS)), and the appropriate code may then be triggered to initialize the remaining software stack of node 200 and either form a new cluster or join an existing cluster, depending on whether any existing nodes are detected. Cluster event manager 240b may also trigger initial network configuration tasks on startup, such as automatic proxy detection, which may involve determining whether the local network is behind a proxy, and if so, configuring node 200 appropriately. Further, cluster event manager 240b may detect and process dynamic changes to the cluster during runtime, such as discovery of new nodes, removal or failure of existing nodes, and so forth.

In some embodiments, cluster event manager 240b may employ a multi-master approach to cluster management. For example, a lightweight gossip protocol may be used to communicate among the nodes of a cluster, detect the various cluster-related events, and coordinate the appropriate actions across the cluster in response to those events. In some embodiments, for example, cluster event manager 240b may be implemented using HashiCorp Serf in combination with custom event-handling logic. For example, HashiCorp Serf may be used to perform event detection, and upon detecting an event, HashiCorp Serf may be configured to trigger other appropriate logic for handling the detected event (e.g., a custom script or other code).

Cluster configuration service 240c provides a key-value store for cluster configuration purposes, as well as a local domain name system (DNS) for communication among cluster nodes on the local network. The key-value store, for example, may specify configuration information associated with each physical node and its associated software stack (e.g., configuration keys for Docker Swarm, GlusterFS). The local DNS may assign randomly generated hostnames to cluster nodes and may perform translations between hostnames and Internet Protocol (IP) addresses locally, thus avoiding the need to use an external DNS service. In some embodiments, cluster configuration service 240c may employ a multi-master approach to cluster configuration and DNS. Further, in some embodiments, cluster configuration service 240c may be implemented using HashiCorp Consul.

Cluster filesystem service 240d provides a scalable distributed real-time file system for storing persisted data across every node in the cluster. In some embodiments, for example, cluster filesystem service 240d mirrors or replicates the same filesystem across each physical node, which results in a single shared filesystem that is locally accessible on the storage drive of each physical node, thus decreasing storage I/O latency compared to network-based storage solutions, such as storage area networks (SANS) and networked attached storage (NAS). For example, cluster filesystem service 240d mirrors files across each physical node, replicates filesystem changes across nodes in real time, performs locking and synchronization for managing access to shared files (e.g., POSIX locking), and so forth. In this manner, every application workload has access to the same local filesystem regardless of which physical node the workload is executing on. Further, multiple petabytes of data can be stored across nodes in a fault-tolerant manner, such as using RAID 1 (e.g., mirroring) or RAID 10 (e.g., mirroring and striping) approaches, among other possibilities. In some embodiments, cluster filesystem service 240d may employ a multi-master approach to filesystem management. Further, in some embodiments, cluster filesystem service 240d may be implemented using GlusterFS.

Dynamic hardware orchestrator (DHO) 240e handles orchestration of hardware resources across the nodes of the cluster. For example, hardware orchestrator 240e enables every hardware resource of every physical node in the cluster—including peripheral device ports such as USB ports and HDMI display ports—to become an available resource for any application workload to make use of, regardless of which physical node(s) the particular workload is executing on. In some embodiments, for example, hardware orchestrator 240e includes a telemetry service to monitor the current system state of node 200 and detect dynamic changes to the available hardware (e.g., newly connected peripheral devices, hardware upgrades). Further, when a new hardware resource is detected (e.g., a USB camera or HDMI display screen), hardware orchestrator 240e may configure the hardware resource as a shared resource available to all other nodes in the cluster. In some embodiments, for example, a container may be launched that makes the hardware resource a global service accessible to all nodes in the cluster. For example, if a peripheral device is plugged into node 200, hardware orchestrator 240e may launch a container that pipes the physical port or interface over the local IP network to other nodes in the cluster. If a USB camera is plugged into node 200, for example, a USB-to-IP container may be launched to stream the USB camera feed from the USB port over the local IP network to other nodes. A similar approach can be used to share other types of hardware resources, such as an HDMI display.

Image replication service 240f maintains an up-to-date library of container images (e.g., Docker images) from its peers on the cluster. In this manner, when a particular workload is assigned to or migrated away from node 200, the appropriate container can simply be “turned on” or “turned off,” as the corresponding container image for that workload is always available locally on node 200. In this manner, latency is reduced for scheduling and migrating workloads across different nodes of the cluster.

Cloud agent 240g communicates with a remote cloud management portal for application provisioning purposes. For example, cloud agent 240g is responsible for provisioning the application(s) associated with the cluster onto node 200. In some embodiments, for example, cloud agent 240g obtains the appropriate container composition files (e.g., Docker compose files) from the cloud and executes them. Cloud agent 240g is also responsible for obtaining over-the-air system updates, such as updates to the operating system kernel.

Development console 240h provides a remotely accessible system console for development purposes, such as development of the containerized applications that execute on node 200. Accordingly, in some embodiments, development console 240h may only be included in the software stack of node 200 during the development stage.

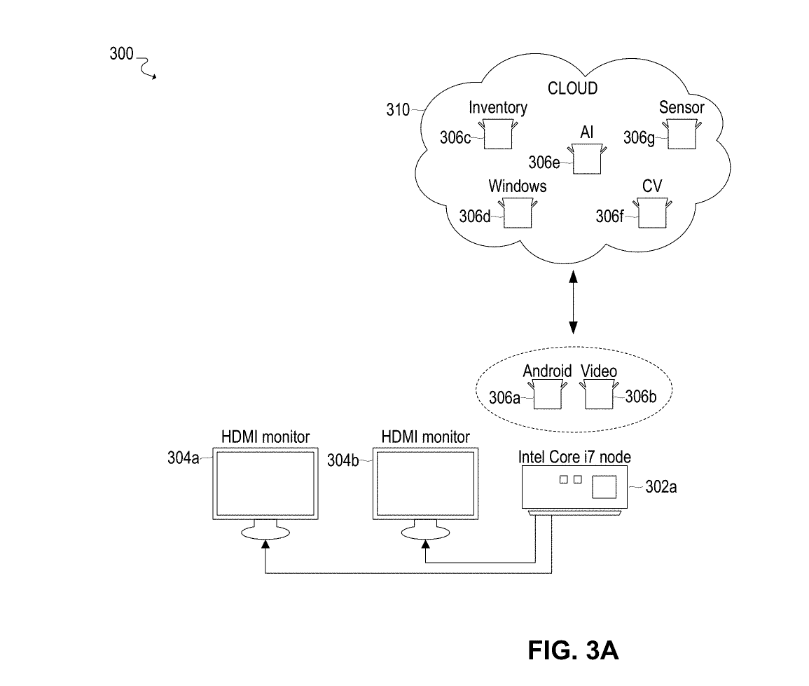

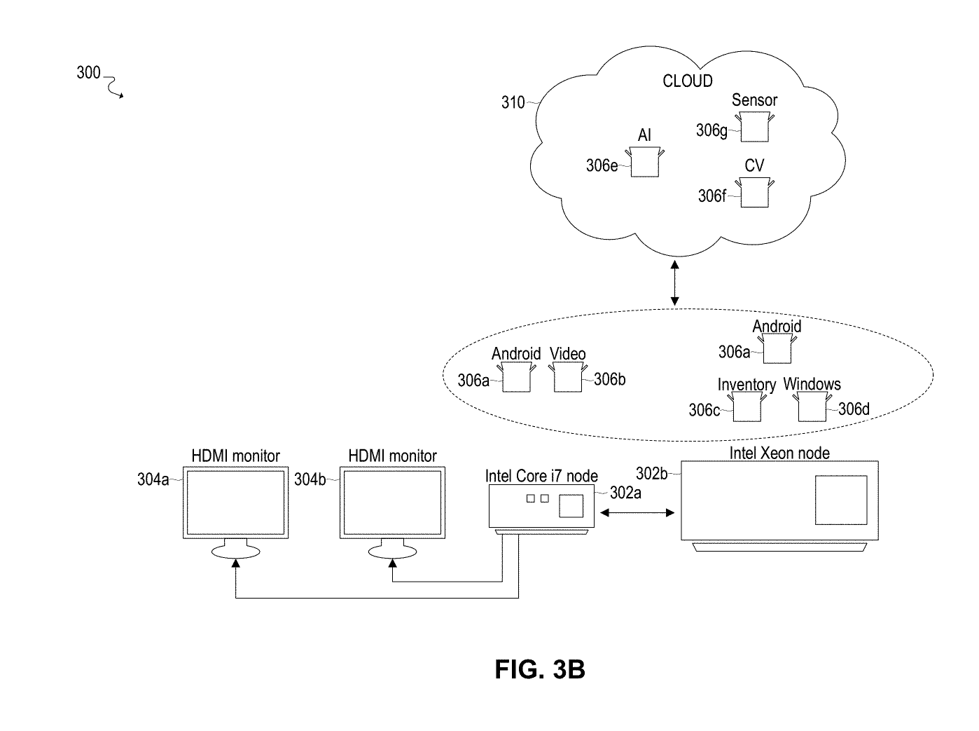

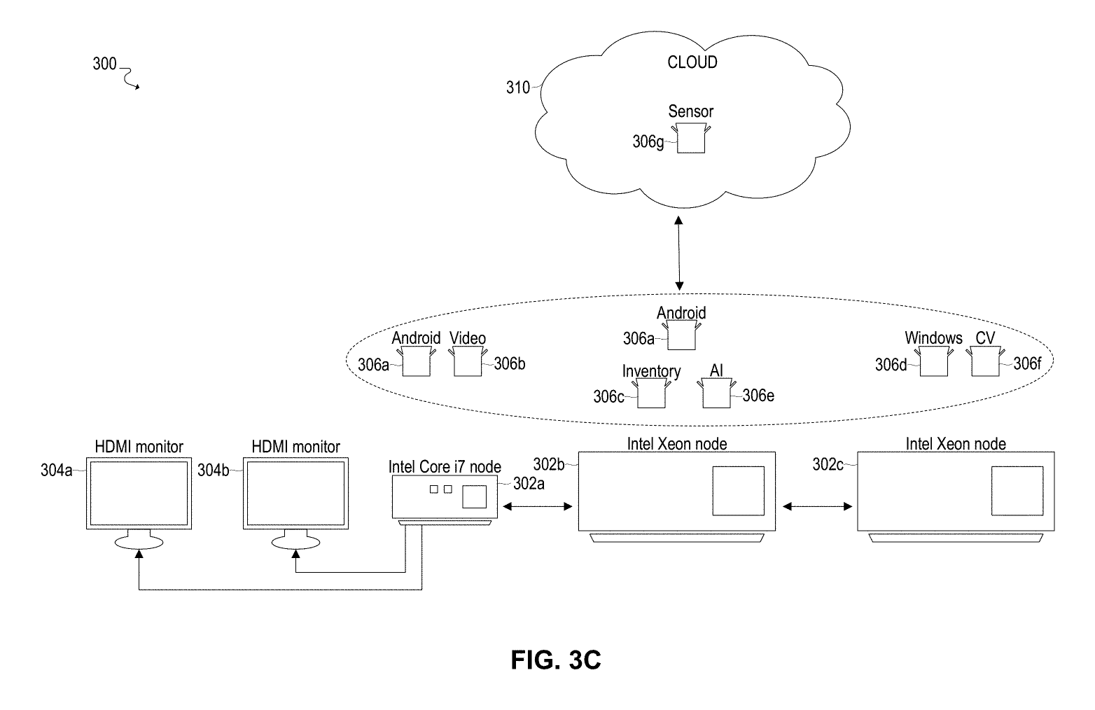

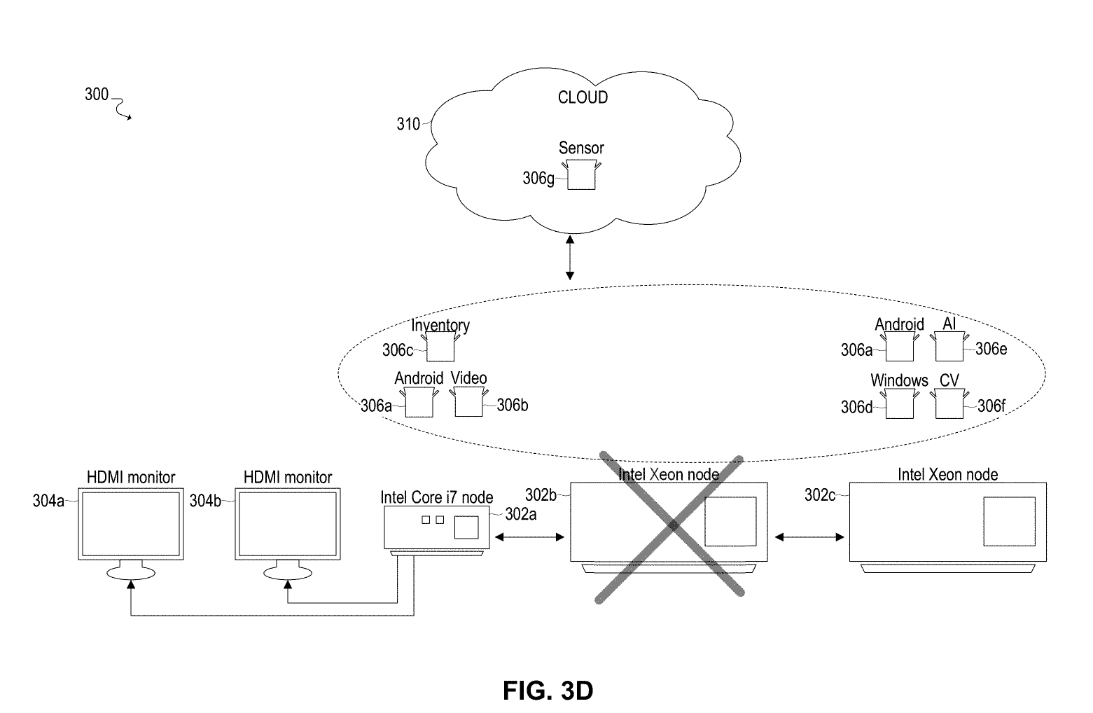

FIGS. 3A-D illustrate an example of the operation of a zero-configuration cluster 300. In some embodiments, for example, the zero-configuration cluster 300 may be implemented using nodes provisioned with the zero-configuration technology stack described in connection with FIG. 2, including Docker Swarm, HashiCorp Serf, HashiCorp Consul, and GlusterFS, along with other components and logic described above.

FIG. 3A illustrates the zero-configuration cluster 300 when a first node 302a is installed. For example, when the first node 302a is installed, plugged into the network, and powered on, it uses HashiCorp Serf to determine whether there are any existing nodes on the network. After determining that node 302a is the first node on the network, Serf begins the cluster initialization process, which includes initializing a Serf cluster, initializing a HashiCorp Consul cluster, initializing a GlusterFS cluster, and initializing a Docker Swarm cluster and declaring itself as the first Swarm node.

The first node 302a then communicates with the cloud 310 in order to provision the appropriate software application, which includes its underlying containers 306a-g and associated composition file(s). The appropriate containers 306a-g are then orchestrated and/or executed on node 302a (e.g., by Docker Swarm) based on the container composition files and the hardware capabilities of node 302a. For example, node 302a detects its available hardware resources (e.g., via a dynamic hardware orchestrator) and determines that multiple displays 304a-b are connected to its HDMI ports. Accordingly, it may be determined that an Android application with a graphical interface should be executed on node 302a. Thus, node 302a may launch an Android container 306a containing a virtual machine with the Android operating system and the associated Android application, along with a video container 306b that makes one of the HDMI monitors 304a-b available as a shared resource on the cluster.

FIG. 3B illustrates the zero-configuration cluster 300 when a second node 302b is installed. When the second node 302b is installed, Serf detects that there is an existing node on the network and thus triggers the process to join the existing cluster, which includes joining the existing Serf cluster, joining the existing Consul cluster, joining the existing GlusterFS cluster, and synchronizing the existing Docker container images to itself. In some embodiments, a secure enrollment process may be performed prior to joining the cluster in order to verify that the second node 302b is authorized to join the existing cluster. The enrollment process may be implemented using any suitable approach, such as a cloud-based authentication process and/or a USB security key, among other possibilities.

Serf then begins a node count analysis process. For example, if Serf determines it is the second node on the network, it begins a process to cause alternating Swarm nodes to self-promote and self-demote themselves to and from being the “master” Swarm node. If Serf determines it is the third node on the network, it promotes all three existing Swarm nodes to master. If Serf determines it is the fourth or higher node on the network, it runs a Swam worker to act as an arbiter among the nodes. Since node 302b is the second node in FIG. 3B, Serf causes alternating Swarm nodes to self-promote and self-demote themselves as the master node.

The appropriate containers 306a-g are then orchestrated and/or executed on the second node 302b (e.g., by Docker Swarm). For example, it may be determined that the second node 302b has more processing resources than the first node 302a, and thus various containers that are computationally-intensive may be launched on the second node 302b, such as another Android container 306a to execute a particular Android application, an inventory container 306c to manage the inventory of a retail store or other business, and a Windows container 306d to execute a particular Windows application.

FIG. 3C illustrates the zero-configuration cluster 300 when a third node 302c is installed. For example, when the third node 302c is installed, Serf initializes the process to join the existing cluster in a similar manner as described above for the second node 302b. Moreover, the appropriate containers are then orchestrated and/or executed across the nodes of the cluster (e.g., by Docker Swarm) based on the addition of the third node 302c. In the illustrated example, the containers on the first node 302a remain the same, a new artificial intelligence (AI) container 306e is launched on the second node 302b, the existing Windows container 306d on the second node 302b is migrated to the third node 302c, and a new computer vision (CV) container 306f is launched on the third node 302c.

FIG. 3D illustrates the zero-configuration cluster 300 when the second node 302b fails or is otherwise removed (e.g., for maintenance). For example, if a node is removed or becomes unavailable, the Serf quorum determines if there is still an elected leader. If not, then a negotiation occurs and an existing Serf node self-promotes to master. The Serf elected leader then begins the process of handling the removal event and the node count analysis. The containers that were previously executing on the second node 302b are migrated to other nodes of the cluster (e.g., by Docker Swarm). For example, the inventory container 306c that was previously on the second node 302b is migrated to the first node 302a, while the Android container 306a and AI container 306e that were previously on the second node 302b are migrated to the third node 302c.

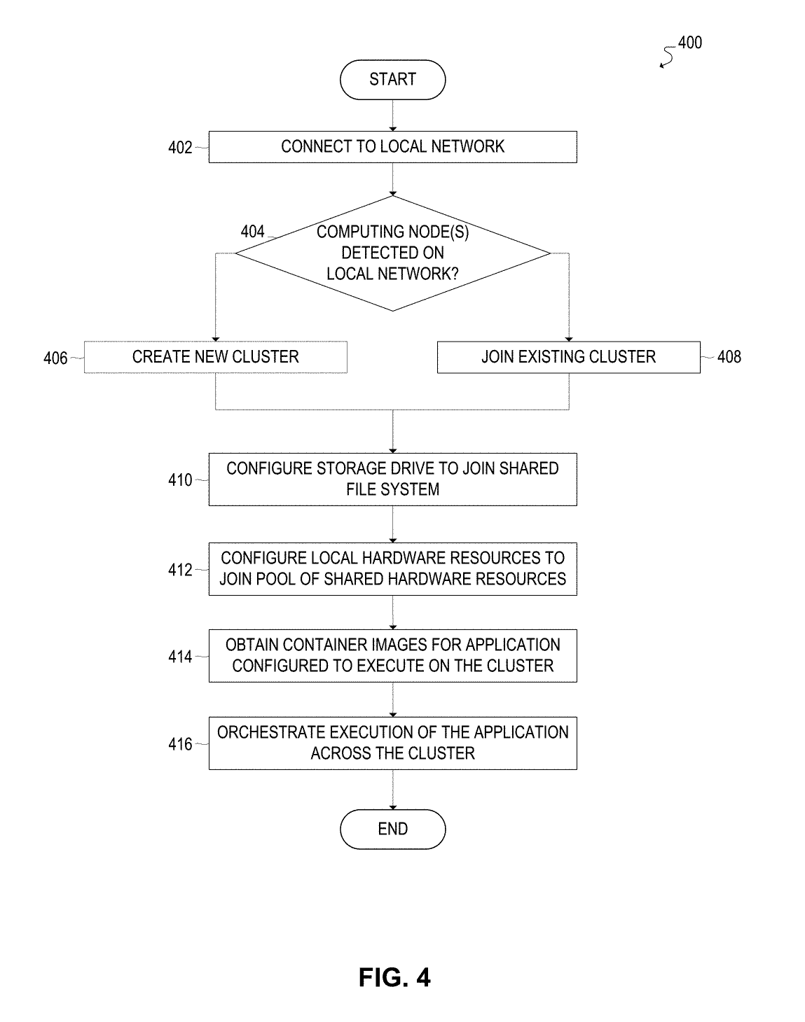

FIG. 4 illustrates a flowchart 400 for an example embodiment of a node for a zero-configuration cluster. In some embodiments, for example, flowchart 400 may be implemented using the embodiments and functionality described throughout this disclosure.

The flowchart begins at block 402, where a new computing node connects to a local network. The new computing node, for example, may be an edge computing appliance with one or more processors, data storage drives, and network interfaces, among other possible components. Moreover, the new computing node may be provisioned with a software stack for participating in a zero-configuration cluster of heterogeneous compute nodes. Further, the node may use an associated network interface to connect to the local network via a router or access point associated with the local network.

The flowchart then proceeds to block 404 to determine whether any existing computing nodes are detected on the local network. In some cases, for example, there may be one or more computing nodes that are already connected to the local network and that have formed a zero-configuration computing cluster. For example, the computing nodes may include a collection of heterogeneous edge processing devices or computing appliances, which may be implemented as bare-metal machines or virtual machines.

Moreover, the computing nodes may be provisioned with a software stack for creating and/or participating in a zero-configuration cluster of heterogeneous compute nodes. In some embodiments, for example, an edge provisioning node (e.g., a computing device or appliance used for provisioning nodes) may be used to automatically pre-provision the zero-configuration software stack on the respective computing nodes.

Further, in some embodiments, the pre-provisioned zero-configuration software stack on the computing nodes may be configured to detect and discover nodes on the local network using multicast DNS. For example, the new computing node may send a multicast DNS packet over the local network to discover or detect any existing computing nodes on the network.

If no existing nodes are detected on the local network, the flowchart proceeds to block 406 to create a new cluster. If there are existing nodes detected on the local network, however, the flowchart proceeds to block 408 to join an existing cluster associated with the detected nodes. In some embodiments, for example, the new computing node may obtain cluster configuration parameters for joining the cluster from one or more of the existing nodes on the cluster, and the new node may configure itself based on the cluster configuration parameters.

The flowchart then proceeds to block 410 to configure a storage drive of the new computing node to join a shared file system associated with the cluster. For example, the storage drive of the new computing node may be configured to provide local access to the shared file system associated with the cluster. The shared file system, for example, may be locally mirrored on each computing node of the cluster, and data written to the shared file system may be replicated across each computing node of the cluster in real time.

The flowchart then proceeds to block 412 to configure local hardware resources of the new computing node to join a pool of shared hardware resources associated with the cluster. In some embodiments, for example, every hardware resource of every computing node on the cluster may be configured as part of a pool of shared hardware resources that are available to all nodes in the cluster. Accordingly, the local hardware resources of the new computing node are configured to join the pool of shared hardware resources.

Further, in some embodiments, the nodes on the cluster may be configured to continuously monitor for changes to their respective local hardware resources. Accordingly, upon detecting that a new local hardware resource has been added to a particular node (e.g., a USB peripheral device, an HDMI display device), the new local hardware resource of that node is added to the pool of shared hardware resources. In some embodiments, for example, a shared resource container is executed for the new local hardware resource to provide the cluster with access to the new resource. If the new resource is a USB device, for example, the shared resource container may be a USB-over-IP service that provides the cluster with access to the USB device over the local network. As another example, if the new local hardware resource is a display device (e.g., an HDMI monitor), the shared resource container may be a service that displays video output from another computing node of the cluster on the display device.

The flowchart then proceeds to block 414, where the new computing node obtains a plurality of container images for an application configured to execute on the cluster. In some cases, for example, the cluster may be configured to execute a particular application implemented using a collection of containers. Accordingly, the new computing node may obtain copies of the container images corresponding to the respective containers of the application. In some cases, for example, the container images may be obtained from other nodes on the cluster and/or from a cloud-based cluster management portal.

The flowchart then proceeds to block 416 to orchestrate execution of the containers of the application across the cluster of computing nodes. For example, the various computing nodes on the cluster may coordinate amongst each other (e.g., using Docker Swarm) to determine which nodes will execute which containers. Accordingly, based on the orchestration, each node may execute some subset of containers associated with the application.

Moreover, the nodes on the cluster may also be configured to monitor for changes to cluster membership, such as when a new node is added to the cluster, or when an existing node fails or is otherwise removed from the local network. For example, upon detecting that a particular node of the cluster has failed, the nodes may re-orchestrate execution of the containers across the cluster, and certain container(s) that were previously executing on the node that failed may be migrated, launched, and/or executed on the remaining nodes of the cluster.

At this point, the flowchart may be complete. In some embodiments, however, the flowchart may restart and/or certain blocks may be repeated. For example, in some embodiments, the flowchart may restart at block 402 to continue adding new nodes to the cluster upon connecting to the local network.

CI/CD Provisioning Pipeline

Continuous integration and continuously delivery (CI/CD) refers to the software development practice of integrating code and delivering new software releases on a frequent and continuous basis. Provisioning the software from a CI/CD pipeline onto heterogeneous bare-metal computing systems can be challenging, however, as existing provisioning solutions are very inefficient and are untethered to the CI/CD pipeline. For example, existing provisioning solutions typically use pre-built disk images that are compiled and built in advance for each type of computing system that the software will be provisioned on. Building “golden” disk images for each physical system is time consuming, however, and adapting to hardware changes is also challenging, as it requires the corresponding images to be completely rebuilt. Further, having developers spend time installing operating systems and iteratively testing their changes is error prone and wastes valuable development time. Accordingly, this disclosure presents various embodiments of a CI/CD provisioning pipeline for heterogeneous computing nodes, as described further below. In some cases, for example, these embodiments could be used to provision heterogeneous computing nodes with a software stack designed to implement a zero-configuration cluster, as described above in connection with FIGS. 2-4.

FIG. 5 illustrates an example computing system 500 with a CI/CD provisioning pipeline for heterogeneous computing nodes. In the illustrated embodiment, system 500 includes edge provisioner 502, computing nodes 504a-c to be provisioned, edge router 506, cloud 510, CI/CD pipeline 512, and provision management portal 514.

In the illustrated embodiment, edge provisioner 502 and edge computing nodes 504a-c are connected to the same local network through edge router 506. Computing nodes 504a-c may include heterogeneous computing nodes (e.g., bare-metal machines and/or virtual machines) that need to be provisioned with certain software. Further, edge provisioner 502 is a computing node that is used to dynamically provision the heterogeneous computing nodes 504a-c from a cloud-based CI/CD pipeline 512.

For example, when a new computing node 504a-c is powered on and connects to the same local network as the edge provisioner 502 (e.g., via edge router 506), or when a new software release becomes available for an existing computing node 504a-c, edge provisioner 502 performs just-in-time provisioning of the requisite software (e.g., the operating system and complete software stack) from the cloud-based CI/CD pipeline 512. In particular, the software is delivered, built, and installed in real time from the CI/CD pipeline 512 to the provisioned computing node 504a-c, which allows the installation process to be dynamically adjusted based on the particular hardware and/or virtual machine characteristics of the provisioned node 504a-c.

In some embodiments, for example, the edge provisioner 502 is managed via a cloud-based management portal 514 (e.g., a web console) driven by Infrastructure as Code (laC). When a target computing node 504a-c needs to be provisioned, the edge provisioner 502 detects the hardware layout of the target node (e.g., regardless of whether it is a physical bare-metal machine or a virtual machine), rapidly deploys an operating system (e.g., in a matter of minutes, such as under five minutes), and then deploys the remaining software stack. The edge provisioner 502 also monitors the CI/CD pipeline 512 for software changes and updates the deployment process in real time. Further, the edge provisioner 502 can support any operating system, along with a variety of platform firmware and boot options, such as the Unified Extensible Firmware Interface (UEFI), legacy BIOS, secure boot, trusted boot, full disk encryption, and so forth.

Moreover, the edge provisioner 502 can perform provisioning for a large number of nodes simultaneously (e.g., 100+ nodes in some cases depending on its underlying processing capabilities), all of which is automatically driven by Infrastructure as Code (laC) from the software development pipeline.

This scalable provisioning of operating systems and software stacks can be leveraged in all stages of the software development lifecycle, including development, validation, evaluation, and production (e.g., on the manufacturing/production floors of system integrators). Further, the functionality of edge provisioner 502 may vary for different stages of the development lifecycle. In some embodiments, for example, separate software development branches may be maintained in the cloud 510 for the different stages of the development lifecycle, and separate edge provisioners 502 may be used to perform provisioning for those different branches/stages. For example, separate software development branches may be maintained in the cloud 510 for development, validation, evaluation, and production/release. Moreover, one or more edge provisioners 502 may be deployed locally to handle provisioning for each branch.

In some embodiments, for example, the edge provisioner 502 used for a particular software branch or development stage may provide a boot menu that allows a user (e.g., developer, tester, or manufacturer) to select which release from that branch to build when a particular node 504a-c needs to be provisioned. Moreover, the edge provisioner 502 may automatically monitor the releases for that branch in real time, thus enabling the provisioning menu to be updated automatically as new releases become available for that branch. This allows development teams to quickly build software platforms on bare-metal or virtual machines.

For example, during the “development” stage, developers continuously release versions of their code, and the edge provisioner 502 presents these versions in a menu system that the developers can select from to test and deploy. Once developers approve their code, they push their release to the “validation” stage, and the validation engineers are presented with a different menu of releases to test and deploy. Once the validation engineers approve the release, the process repeats for “evaluators,” and then finally for production release. During production release, the edge provisioner 502 does not provide a provisioning menu—the latest code is simply deployed on the target bare-metal or virtual machines.

This iterative deployment model from development to production is highly automated to reproduce repeatable and consistent operating system and software stacks on target hardware or virtual machines. In this manner, developers are no longer burdened with the hassle of deploying operating systems for iterative testing. Moreover, manufacturing vendors are no longer required to produce computing systems using exclusive hardware components with specific stock keeping unit (SKU) identifiers. As an example, the manufacturer of a particular computing system has greater flexibility to select from disk drives of varying sizes based on market value at the time of manufacturing, rather than being limited exclusively to a single disk drive with a specific SKU.

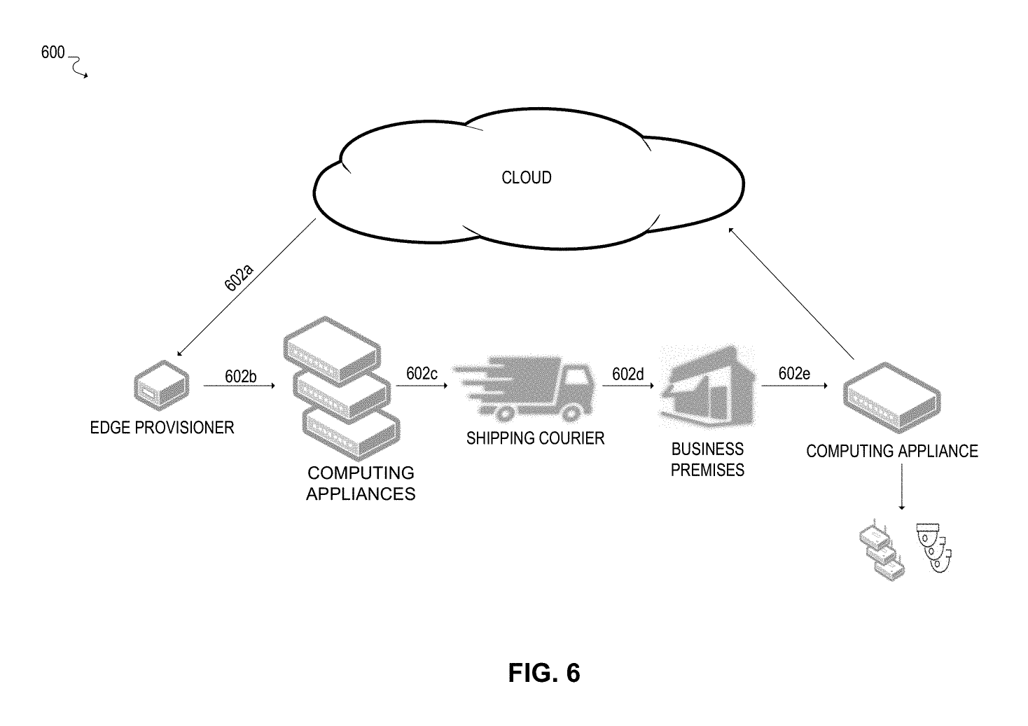

FIG. 6 illustrates an example of the provisioning process 600 from a system integrator to a customer. At step 602a, software is released and pushed to the CI/CD cloud, and inside the system integrator's facilities, the edge provisioner monitors for software releases in the cloud, pulls new software releases from the cloud, and updates its local files. At step 602b, a customer places an order with the system integrator, and the system integrator begins building computing appliances using the edge provisioner. At step 602c, a computing appliance is shipped to the customer's business premises, such as a retail store location. During transit, the computing appliance contains no store specific information in order to protect against enrollment attack vectors. At step 602d, the computing appliance is installed at the customer's retail location. A technician or store employee enrolls the appliance via their cloud-based management account. At step 602e, the computing appliance connects back to the management cloud at power up. The zero-configuration software provisioned on the computing appliance downloads the applications configured for that retail location. All sensors and applications then become active.

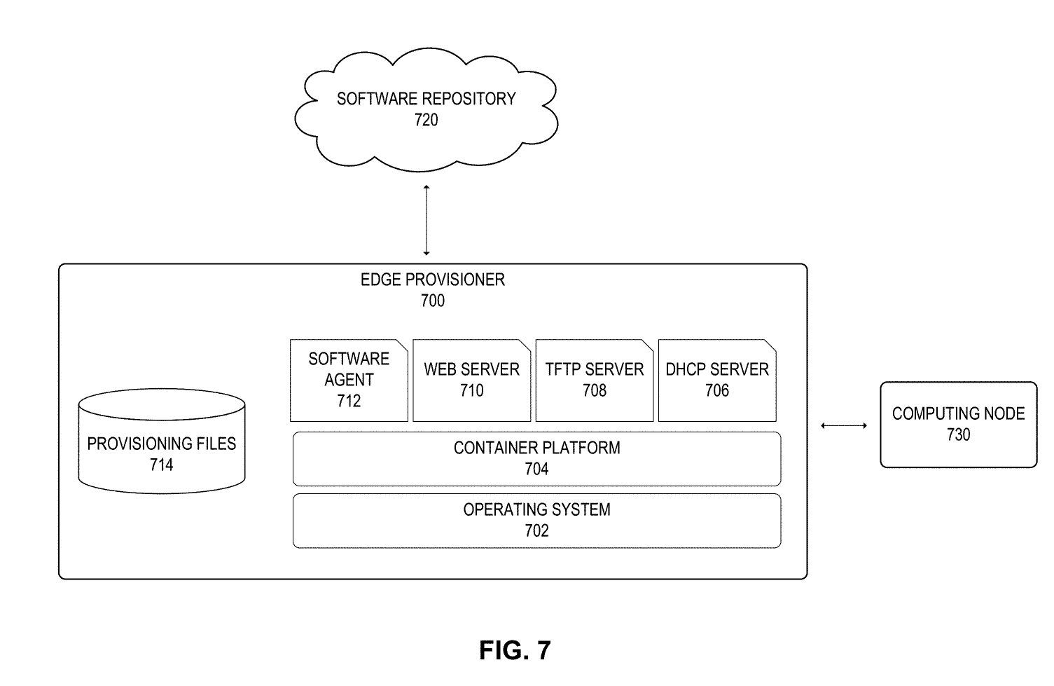

FIG. 7 illustrates an example embodiment of an edge provisioner 700. In some embodiments, for example, edge provisioner 700 may be used to dynamically provision a computing node 730 with software maintained in a cloud-based software repository 720, as described further below.

In the illustrated embodiment, edge provisioner 700 includes operating system 702 (e.g., a Linux distribution such as RancherOS), container platform 704 (e.g., Docker), dynamic host configuration protocol (DHCP) server 706, trivial file transfer protocol (TFTP) server 708, web server 710 (e.g., NGINX or Apache), software agent 712, and provisioning files 714.

DHCP server 706 facilitates the initial preboot execution environment (PXE) discovery for a computing node 730 that is being provisioned by edge provisioner 700. For example, upon receiving a legacy BIOS or UEFI boot request from a computing node 730, DHCP server 706 sends the internet protocol (IP) address of the TFTP server 708 that contains the initial bootloader and boot menu for the computing node 730.

TFTP server 708 provides a file transfer service that enables computing node 730 to pull various initial provisioning files 714, including the initial bootloader, initial boot menu, kernel, and initial ramdisk.

Web server 710 provides an http service that enables computing node 730 to pull additional provisioning files 714, including an initial “kick start” file and any additional files, such as container images, installation packages, and so forth. The initial kick start file, for example, contains the instruction set to pull from a cloud-based software repository 720 (e.g., GitHub or Gitea).

Software agent 712 maintains a constant connection to the cloud-based software repository 720, monitors for changes to the repository, and updates the boot menu used for provisioning when new software is released. In some embodiments, for example, software agent 712 may be implemented using an Ansible script.

Software repository 720 (e.g., GitHub or Gitea) is an external cloud-based software repository that is used to maintain the bootstrap process for provisioning. This is the actual instruction set to start installing and building the operating system on the computing node 730.

Computing node 730 is the computing appliance that is being provisioned by edge provisioner 700, which can be either a physical bare-metal machine or a virtual machine.

The provisioning process performed by edge provisioner 700 involves the software agent 712 continuously and/or periodically checking for changes to a specific branch in the software repository 720. In some embodiments, for example, an Ansible script runs every few minutes to check for changes to a specific repository branch in GitHub or Gitea. When changes are detected, the boot menu is updated and the new files are pulled from the repository and cached via the Ansible script.

When computing node 730 (e.g., a bare-metal or virtual machine) to be provisioned is powered on, it sends a PXE boot broadcast over the local network, and the DHCP server 706 responds with information on where to pull the bootloader and boot menu, such as the IP address of the TFTP server 708 that contains those files.

The bootloader and boot menu are pulled from the TFTP server 708 and displayed to a user, and the user selects the build that the user wants to deploy. Alternatively, in some cases, such as in production or on the manufacturing floor, no menu appears and only the default kernel is booted for a build.

The computing node 730 pulls the kernel and initial ram disk from the TFTP server 708. After the kernel boots on the computing node 730, the initial ram disk pulls the “kick start” file over HTTP from the web server 710 of edge provisioner 700. The “kick start” file then pulls the “bootstrap” file from the external software repository 720, such as GitHub or Gitea.

The complete operating system and software stack is then installed on computing node 730 in a matter of minutes. If the user is a developer, the computing node 730 reboots when the provisioning is complete. On the production line, however, the computing node 730 is powered off when the provisioning is complete, and an alert of completion is sent to the user.

When the computing node 730 is subsequently installed at a customer location, such as a retail store, the computing node 730 automatically configures itself and install any customer-specific software (e.g., as described further in connection with the zero-configuration cluster).

Example Internet-of-Things (IoT) Implementations

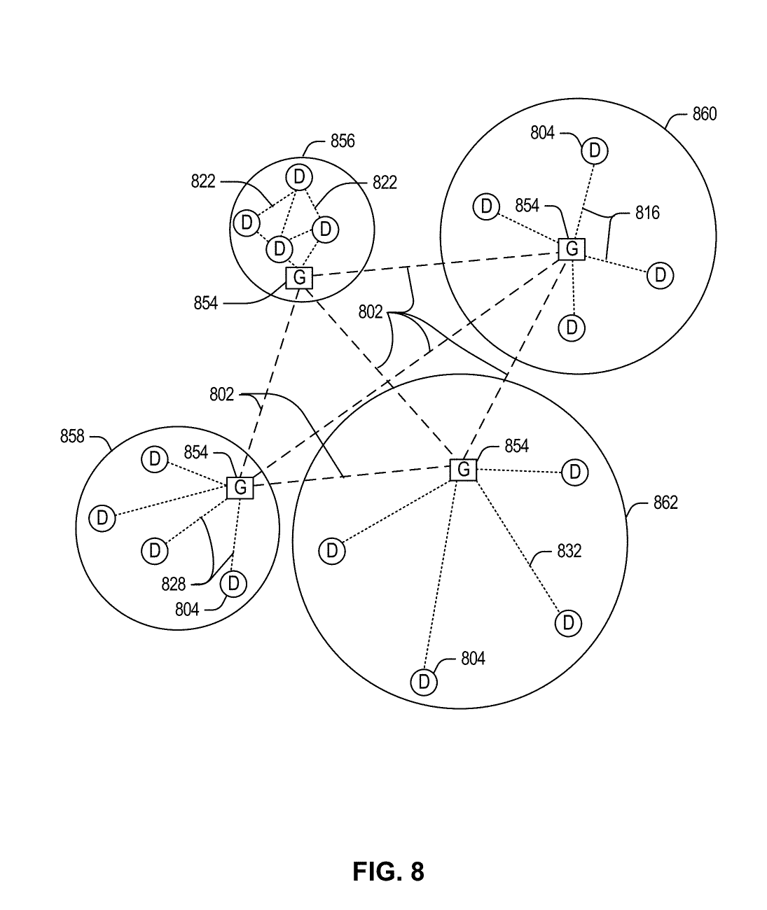

FIGS. 8-11 illustrate examples of Internet-of-Things (IoT) networks and devices that can be used in accordance with embodiments disclosed herein. For example, the operations and functionality described throughout this disclosure may be embodied by an IoT device or machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 8 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 8-11, present a number of new challenges in a heterogeneous network of connectivity comprising a combination of wired and wireless technologies.

FIG. 8 specifically provides a simplified drawing of a domain topology that may be used for a number of internet-of-things (IoT) networks comprising IoT devices 804, with the IoT networks 856, 858, 860, 862, coupled through backbone links 802 to respective gateways 854. For example, a number of IoT devices 804 may communicate with a gateway 854, and with each other through the gateway 854. To simplify the drawing, not every IoT device 804, or communications link (e.g., link 816, 822, 828, or 832) is labeled. The backbone links 802 may include any number of wired or wireless technologies, including optical networks, and may be part of a local area network (LAN), a wide area network (WAN), or the Internet. Additionally, such communication links facilitate optical signal paths among both IoT devices 804 and gateways 854, including the use of MUXing/deMUXing components that facilitate interconnection of the various devices.

The network topology may include any number of types of IoT networks, such as a mesh network provided with the network 856 using Bluetooth low energy (BLE) links 822. Other types of IoT networks that may be present include a wireless local area network (WLAN) network 858 used to communicate with IoT devices 804 through IEEE 802.11 (Wi-Fi®) links 828, a cellular network 860 used to communicate with IoT devices 804 through an LTE/LTE-A (4G) or 5G cellular network, and a low-power wide area (LPWA) network 862, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 804, such as over the backbone links 802, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 856, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 858, for instance, may use systems that perform standards conversion to provide multi-standard connectivity, enabling IoT devices 804 using different protocols to communicate. Further systems may provide seamless interconnectivity across a multi-standard infrastructure comprising visible Internet resources and hidden Internet resources.

Communications in the cellular network 860, for instance, may be enhanced by systems that offload data, extend communications to more remote devices, or both. The LPWA network 862 may include systems that perform non-Internet protocol (IP) to IP interconnections, addressing, and routing. Further, each of the IoT devices 804 may include the appropriate transceiver for wide area communications with that device. Further, each IoT device 804 may include other transceivers for communications using additional protocols and frequencies.

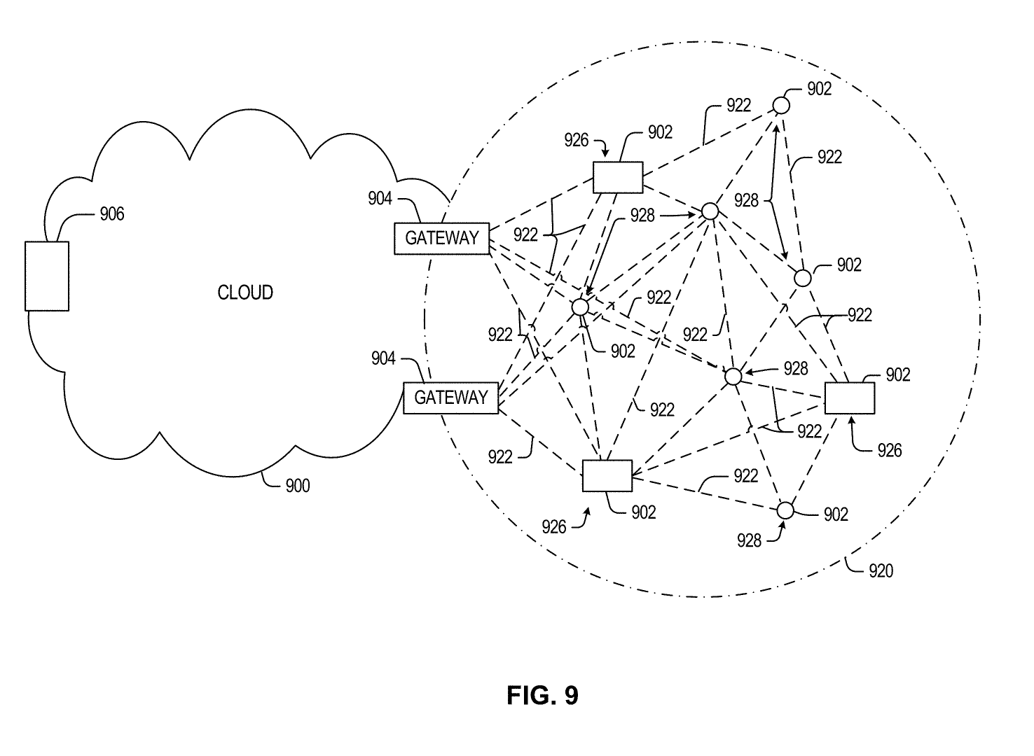

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 9 below.

FIG. 9 illustrates a cloud computing network in communication with a mesh network of IoT devices (devices 902) operating as a fog device at the edge of the cloud computing network. The mesh network of IoT devices may be termed a fog 920, operating at the edge of the cloud 900. To simplify the diagram, not every IoT device 902 is labeled.

The fog 920 may be considered to be a massively interconnected network wherein a number of IoT devices 902 are in communications with each other, for example, by radio links 922. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 902 are shown in this example, gateways 904, data aggregators 926, and sensors 928, although any combinations of IoT devices 902 and functionality may be used. The gateways 904 may be edge devices that provide communications between the cloud 900 and the fog 920, and may also provide the backend process function for data obtained from sensors 928, such as motion data, flow data, temperature data, and the like. The data aggregators 926 may collect data from any number of the sensors 928, and perform the back-end processing function for the analysis. The results, raw data, or both may be passed along to the cloud 900 through the gateways 904. The sensors 928 may be full IoT devices 902, for example, capable of both collecting data and processing the data. In some cases, the sensors 928 may be more limited in functionality, for example, collecting the data and allowing the data aggregators 926 or gateways 904 to process the data.

Communications from any IoT device 902 may be passed along a convenient path (e.g., a most convenient path) between any of the IoT devices 902 to reach the gateways 904. In these networks, the number of interconnections provide substantial redundancy, allowing communications to be maintained, even with the loss of a number of IoT devices 902. Further, the use of a mesh network may allow IoT devices 902 that are very low power or located at a distance from infrastructure to be used, as the range to connect to another IoT device 902 may be much less than the range to connect to the gateways 904.

The fog 920 provided from these IoT devices 902 may be presented to devices in the cloud 900, such as a server 906, as a single device located at the edge of the cloud 900, e.g., a fog device. In this example, the alerts coming from the fog device may be sent without being identified as coming from a specific IoT device 902 within the fog 920. In this fashion, the fog 920 may be considered a distributed platform that provides computing and storage resources to perform processing or data-intensive tasks such as data analytics, data aggregation, and machine-learning, among others.

In some examples, the IoT devices 902 may be configured using an imperative programming style, e.g., with each IoT device 902 having a specific function and communication partners. However, the IoT devices 902 forming the fog device may be configured in a declarative programming style, allowing the IoT devices 902 to reconfigure their operations and communications, such as to determine needed resources in response to conditions, queries, and device failures. As an example, a query from a user located at a server 906 about the operations of a subset of equipment monitored by the IoT devices 902 may result in the fog 920 device selecting the IoT devices 902, such as particular sensors 928, needed to answer the query. The data from these sensors 928 may then be aggregated and analyzed by any combination of the sensors 928, data aggregators 926, or gateways 904, before being sent on by the fog 920 device to the server 906 to answer the query. In this example, IoT devices 902 in the fog 920 may select the sensors 928 used based on the query, such as adding data from flow sensors or temperature sensors. Further, if some of the IoT devices 902 are not operational, other IoT devices 902 in the fog 920 device may provide analogous data, if available.

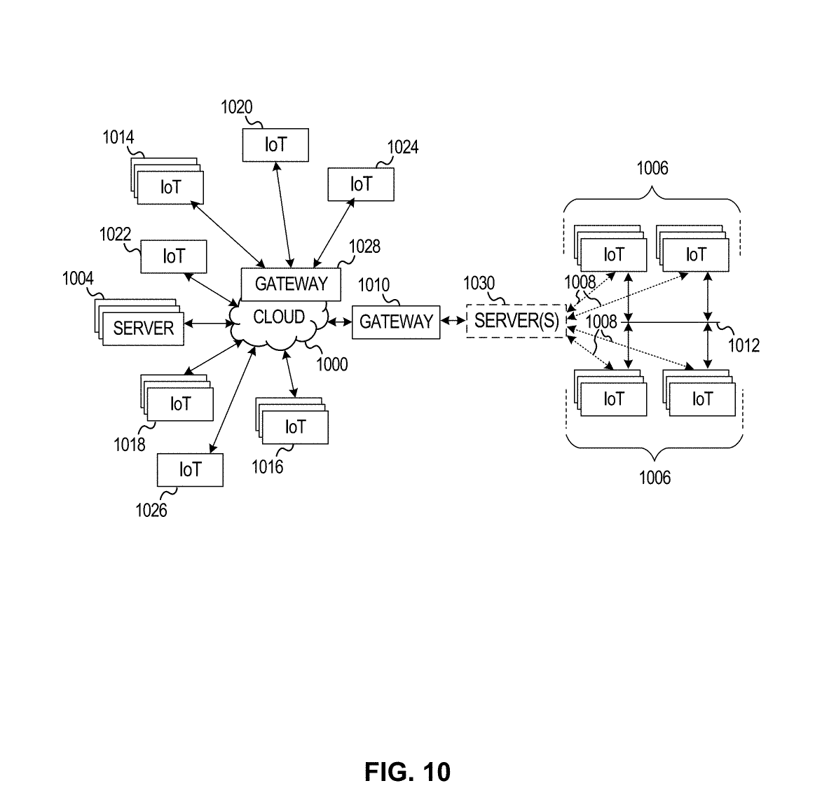

FIG. 10 illustrates a drawing of a cloud computing network, or cloud 1000, in communication with a number of Internet of Things (IoT) devices. The cloud 1000 may represent the Internet, or may be a local area network (LAN), or a wide area network (WAN), such as a proprietary network for a company. The IoT devices may include any number of different types of devices, grouped in various combinations. For example, a traffic control group 1006 may include IoT devices along streets in a city. These IoT devices may include stoplights, traffic flow monitors, cameras, weather sensors, and the like. The traffic control group 1006, or other subgroups, may be in communication with the cloud 1000 through wired or wireless links 1008, such as LPWA links, optical links, and the like. Further, a wired or wireless sub-network 1012 may allow the IoT devices to communicate with each other, such as through a local area network, a wireless local area network, and the like. The IoT devices may use another device, such as a gateway 1010 or 1028 to communicate with remote locations such as the cloud 1000; the IoT devices may also use one or more servers 1030 to facilitate communication with the cloud 1000 or with the gateway 1010. For example, the one or more servers 1030 may operate as an intermediate network node to support a local edge cloud or fog implementation among a local area network. Further, the gateway 1028 that is depicted may operate in a cloud-to-gateway-to-many edge devices configuration, such as with the various IoT devices 1014, 1020, 1024 being constrained or dynamic to an assignment and use of resources in the cloud 1000.

Other example groups of IoT devices may include remote weather stations 1014, local information terminals 1016, alarm systems 1018, automated teller machines 1020, alarm panels 1022, or moving vehicles, such as emergency vehicles 1024 or other vehicles 1026, among many others. Each of these IoT devices may be in communication with other IoT devices, with servers 1004, with another IoT fog device or system (not shown, but depicted in FIG. 9), or a combination therein. The groups of IoT devices may be deployed in various residential, commercial, and industrial settings (including in both private or public environments).

As can be seen from FIG. 10, a large number of IoT devices may be communicating through the cloud 1000. This may allow different IoT devices to request or provide information to other devices autonomously. For example, a group of IoT devices (e.g., the traffic control group 1006) may request a current weather forecast from a group of remote weather stations 1014, which may provide the forecast without human intervention. Further, an emergency vehicle 1024 may be alerted by an automated teller machine 1020 that a burglary is in progress. As the emergency vehicle 1024 proceeds towards the automated teller machine 1020, it may access the traffic control group 1006 to request clearance to the location, for example, by lights turning red to block cross traffic at an intersection in sufficient time for the emergency vehicle 1024 to have unimpeded access to the intersection.

Clusters of IoT devices, such as the remote weather stations 1014 or the traffic control group 1006, may be equipped to communicate with other IoT devices as well as with the cloud 1000. This may allow the IoT devices to form an ad-hoc network between the devices, allowing them to function as a single device, which may be termed a fog device or system (e.g., as described above with reference to FIG. 9).

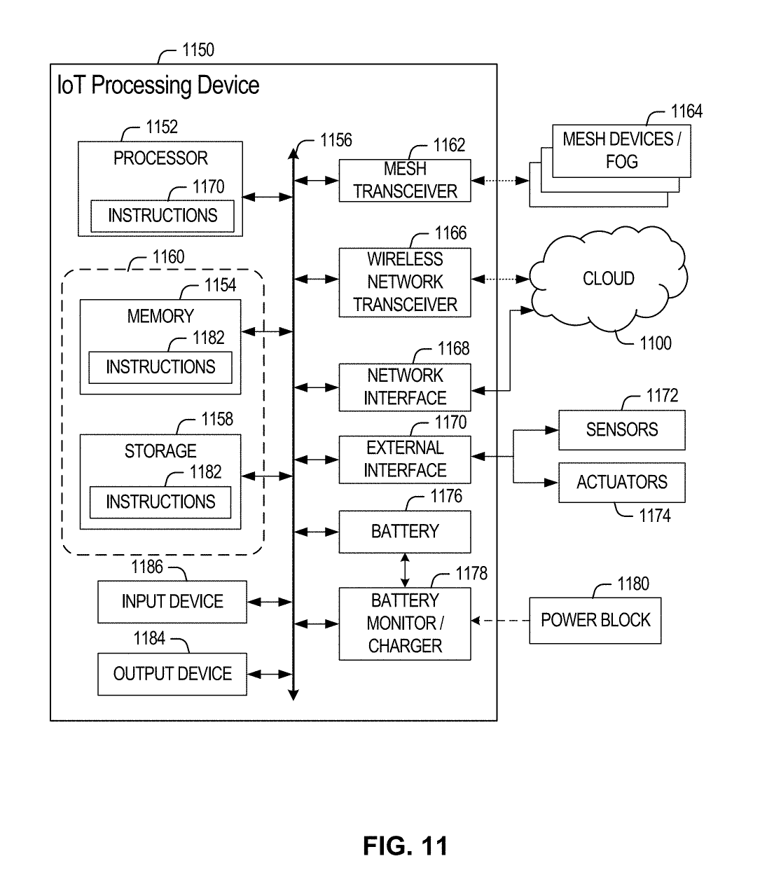

FIG. 11 is a block diagram of an example of components that may be present in an IoT device 1150 for implementing the techniques described herein. The IoT device 1150 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1150, or as components otherwise incorporated within a chassis of a larger system. Additionally, the block diagram of FIG. 11 is intended to depict a high-level view of components of the IoT device 1150. However, some of the components shown may be omitted, additional components may be present, and different arrangement of the components shown may occur in other implementations.

The IoT device 1150 may include a processor 1152, which may be a microprocessor, a multi-core processor, a multithreaded processor, an ultra-low voltage processor, an embedded processor, or other known processing element. The processor 1152 may be a part of a system on a chip (SoC) in which the processor 1152 and other components are formed into a single integrated circuit, or a single package, such as the Edison™ or Galileo™ SoC boards from Intel. As an example, the processor 1152 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1152 may communicate with a system memory 1154 over an interconnect 1156 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 1158 may also couple to the processor 1152 via the interconnect 1156. In an example, the storage 1158 may be implemented via a solid state disk drive (SSDD). Other devices that may be used for the storage 1158 include flash memory cards, such as SD cards, microSD cards, xD picture cards, and the like, and USB flash drives. In low power implementations, the storage 1158 may be on-die memory or registers associated with the processor 1152. However, in some examples, the storage 1158 may be implemented using a micro hard disk drive (HDD). Further, any number of new technologies may be used for the storage 1158 in addition to, or instead of, the technologies described, such resistance change memories, phase change memories, holographic memories, or chemical memories, among others.

The components may communicate over the interconnect 1156. The interconnect 1156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1156 may be a proprietary bus, for example, used in a SoC based system. Other bus systems may be included, such as an I2C interface, an SPI interface, point to point interfaces, and a power bus, among others.

The interconnect 1156 may couple the processor 1152 to a mesh transceiver 1162, for communications with other mesh devices 1164. The mesh transceiver 1162 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1164. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1162 may communicate using multiple standards or radios for communications at different range. For example, the IoT device 1150 may communicate with close devices, e.g., within about 10 meters, using a local transceiver based on BLE, or another low power radio, to save power. More distant mesh devices 1164, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1166 may be included to communicate with devices or services in the cloud 1100 via local or wide area network protocols. The wireless network transceiver 1166 may be a LPWA transceiver that follows the IEEE 802.15.4, or IEEE 802.15.4g standards, among others. The IoT device 1150 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1162 and wireless network transceiver 1166, as described herein. For example, the radio transceivers 1162 and 1166 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1162 and 1166 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1166, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1168 may be included to provide a wired communication to the cloud 1100 or to other devices, such as the mesh devices 1164. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1168 may be included to allow connect to a second network, for example, a NIC 1168 providing communications to the cloud over Ethernet, and a second NIC 1168 providing communications to other devices over another type of network.

The interconnect 1156 may couple the processor 1152 to an external interface 1170 that is used to connect external devices or subsystems. The external devices may include sensors 1172, such as accelerometers, level sensors, flow sensors, optical light sensors, camera sensors, temperature sensors, a global positioning system (GPS) sensors, pressure sensors, barometric pressure sensors, and the like. The external interface 1170 further may be used to connect the IoT device 1150 to actuators 1174, such as power switches, valve actuators, an audible sound generator, a visual warning device, and the like.

In some optional examples, various input/output (I/O) devices may be present within, or connected to, the IoT device 1150. For example, a display or other output device 1184 may be included to show information, such as sensor readings or actuator position. An input device 1186, such as a touch screen or keypad may be included to accept input. An output device 1184 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1150.

A battery 1176 may power the IoT device 1150, although in examples in which the IoT device 1150 is mounted in a fixed location, it may have a power supply coupled to an electrical grid. The battery 1176 may be a lithium ion battery, or a metal-air battery, such as a zinc-air battery, an aluminum-air battery, a lithium-air battery, and the like.

A battery monitor/charger 1178 may be included in the IoT device 1150 to track the state of charge (SoCh) of the battery 1176. The battery monitor/charger 1178 may be used to monitor other parameters of the battery 1176 to provide failure predictions, such as the state of health (SoH) and the state of function (SoF) of the battery 1176. The battery monitor/charger 1178 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1178 may communicate the information on the battery 1176 to the processor 1152 over the interconnect 1156. The battery monitor/charger 1178 may also include an analog-to-digital (ADC) convertor that allows the processor 1152 to directly monitor the voltage of the battery 1176 or the current flow from the battery 1176. The battery parameters may be used to determine actions that the IoT device 1150 may perform, such as transmission frequency, mesh network operation, sensing frequency, and the like.

A power block 1180, or other power supply coupled to a grid, may be coupled with the battery monitor/charger 1178 to charge the battery 1176. In some examples, the power block 1180 may be replaced with a wireless power receiver to obtain the power wirelessly, for example, through a loop antenna in the IoT device 1150. A wireless battery charging circuit, such as an LTC4020 chip from Linear Technologies of Milpitas, Calif., among others, may be included in the battery monitor/charger 1178. The specific charging circuits chosen depend on the size of the battery 1176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1158 may include instructions 1182 in the form of software, firmware, or hardware commands to implement the techniques described herein. Although such instructions 1182 are shown as code blocks included in the memory 1154 and the storage 1158, it may be understood that any of the code blocks may be replaced with hardwired circuits, for example, built into an application specific integrated circuit (ASIC).

In an example, the instructions 1182 provided via the memory 1154, the storage 1158, or the processor 1152 may be embodied as a non-transitory, machine readable medium 1160 including code to direct the processor 1152 to perform electronic operations in the IoT device 1150. The processor 1152 may access the non-transitory, machine readable medium 1160 over the interconnect 1156. For instance, the non-transitory, machine readable medium 1160 may include storage units such as optical disks, flash drives, or any number of other hardware devices. The non-transitory, machine readable medium 1160 may include instructions to direct the processor 1152 to perform a specific sequence or flow of actions, for example, as described with respect to the flowchart(s) and diagram(s) of operations and functionality described throughout this disclosure.

Example Computing Architectures

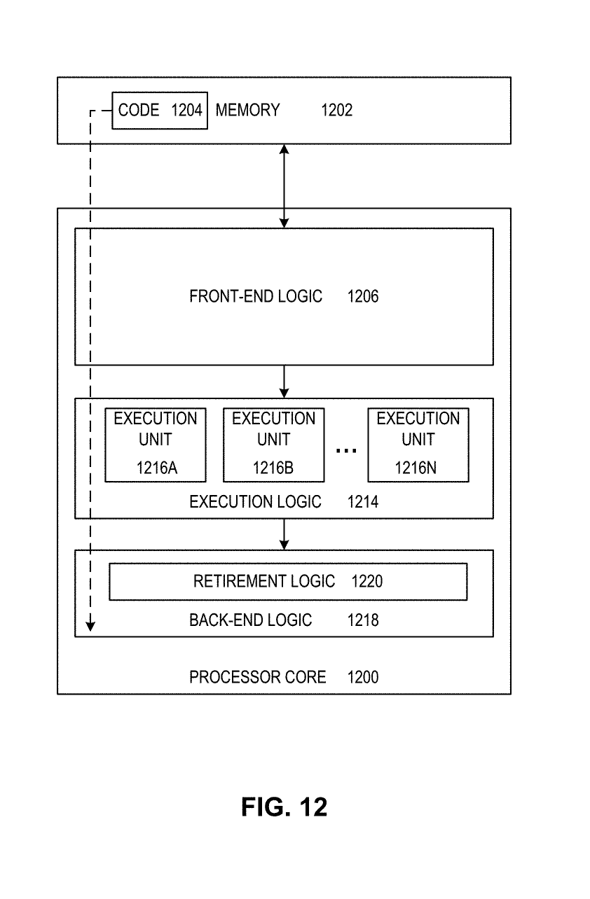

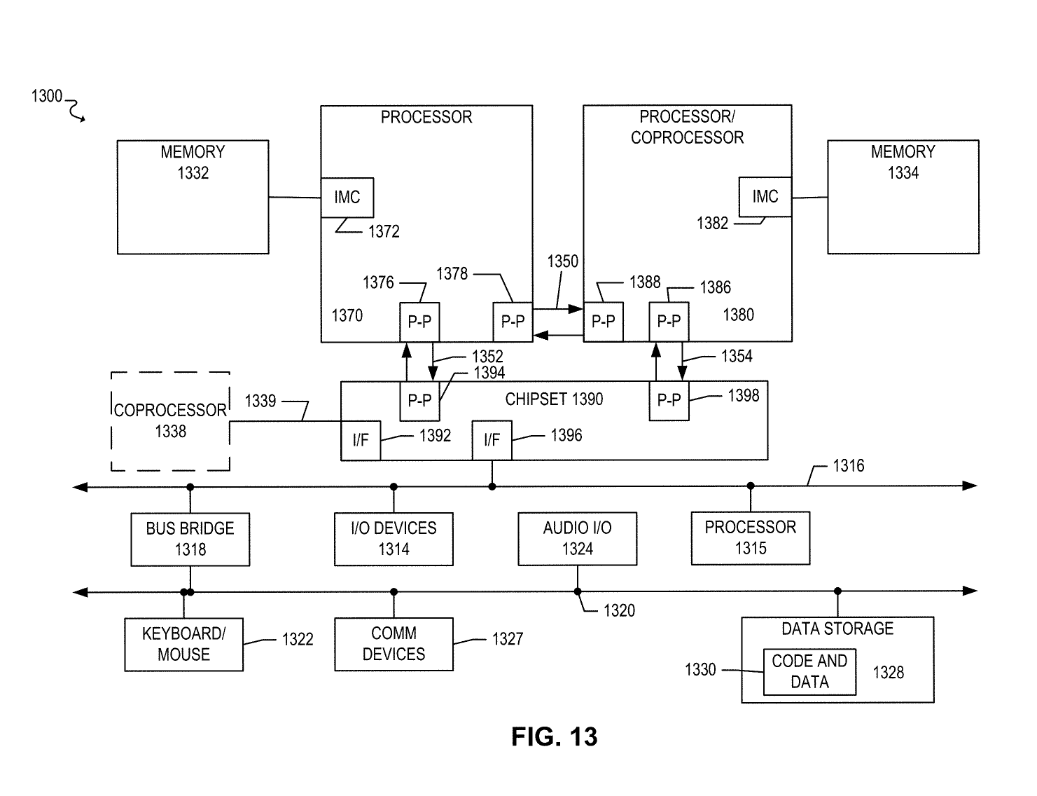

FIGS. 12 and 13 illustrate example computer processor architectures that can be used in accordance with embodiments disclosed herein. For example, in various embodiments, the computer architectures of FIGS. 12 and 13 may be used to implement the functionality described throughout this disclosure. Other embodiments may use other processor and system designs and configurations known in the art, for example, for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 12 illustrates a block diagram for an example embodiment of a processor 1200. Processor 1200 is an example of a type of hardware device that can be used in connection with the embodiments described throughout this disclosure. Processor 1200 may be any type of processor, such as a microprocessor, an embedded processor, a digital signal processor (DSP), a network processor, a multi-core processor, a single core processor, or other device to execute code. Although only one processor 1200 is illustrated in FIG. 12, a processing element may alternatively include more than one of processor 1200 illustrated in FIG. 12. Processor 1200 may be a single-threaded core or, for at least one embodiment, the processor 1200 may be multithreaded in that it may include more than one hardware thread context (or “logical processor”) per core.

FIG. 12 also illustrates a memory 1202 coupled to processor 1200 in accordance with an embodiment. Memory 1202 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1200 can execute any type of instructions associated with algorithms, processes, or operations detailed herein. Generally, processor 1200 can transform an element or an article (e.g., data) from one state or thing to another state or thing.

Code 1204, which may be one or more instructions to be executed by processor 1200, may be stored in memory 1202, or may be stored in software, hardware, firmware, or any suitable combination thereof, or in any other internal or external component, device, element, or object where appropriate and based on particular needs. In one example, processor 1200 can follow a program sequence of instructions indicated by code 1204. Each instruction enters a front-end logic 1206 and is processed by one or more decoders 1208. The decoder may generate, as its output, a micro operation such as a fixed width micro operation in a predefined format, or may generate other instructions, microinstructions, or control signals that reflect the original code instruction. Front-end logic 1206 may also include register renaming logic and scheduling logic, which generally allocate resources and queue the operation corresponding to the instruction for execution.

Processor 1200 can also include execution logic 1214 having a set of execution units 1216a, 1216b, 1216n, etc. Some embodiments may include a number of execution units dedicated to specific functions or sets of functions. Other embodiments may include only one execution unit or one execution unit that can perform a particular function. Execution logic 1214 performs the operations specified by code instructions.

After completion of execution of the operations specified by the code instructions, back-end logic 1218 can retire the instructions of code 1204. In one embodiment, processor 1200 allows out of order execution but requires in order retirement of instructions. Retirement logic 1220 may take a variety of known forms (e.g., re-order buffers or the like). In this manner, processor 1200 is transformed during execution of code 1204, at least in terms of the output generated by the decoder, hardware registers and tables utilized by register renaming logic 1210, and any registers (not shown) modified by execution logic 1214.

Although not shown in FIG. 12, a processing element may include other elements on a chip with processor 1200. For example, a processing element may include memory control logic along with processor 1200. The processing element may include I/O control logic and/or may include I/O control logic integrated with memory control logic. The processing element may also include one or more caches. In some embodiments, non-volatile memory (such as flash memory or fuses) may also be included on the chip with processor 1200.

FIG. 13 illustrates a block diagram for an example embodiment of a multiprocessor 1300. As shown in FIG. 13, multiprocessor system 1300 is a point-to-point interconnect system, and includes a first processor 1370 and a second processor 1380 coupled via a point-to-point interconnect 1350. In some embodiments, each of processors 1370 and 1380 may be some version of processor 1200 of FIG. 12.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339. In one embodiment, the coprocessor 1338 is a special-purpose processor, such as, for example, a high-throughput MIC processor, a network or communication processor, compression engine, graphics processor, GPGPU, embedded processor, matrix processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of this disclosure is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), matrix processors, field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 13, a system may implement a multi-drop bus or other such architecture.

All or part of any component of FIG. 13 may be implemented as a separate or stand-alone component or chip, or may be integrated with other components or chips, such as a system-on-a-chip (SoC) that integrates various computer components into a single chip.

Embodiments of the mechanisms disclosed herein may be implemented in hardware, software, firmware, or a combination of such implementation approaches. Certain embodiments may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of this disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing disclosure outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

As used throughout this specification, the term “processor” or “microprocessor” should be understood to include not only a traditional microprocessor (such as Intel's° industry-leading x86 and x64 architectures), but also graphics processors, matrix processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations. A non-transitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### Example Implementations

The following examples pertain to embodiments described throughout this disclosure.

One or more embodiments may include an apparatus, comprising: a network interface to communicate over a local network; a storage drive; and a processor to: connect to the local network via the network interface; detect a plurality of computing nodes on the local network, wherein the plurality of computing nodes comprise a plurality of heterogeneous edge processing devices; join a cluster of computing nodes, wherein the cluster of computing nodes comprises the plurality of computing nodes on the local network; configure the storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time; configure one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster; obtain a plurality of container images for an application configured to execute on the cluster, wherein the plurality of container images are for executing a plurality of containers associated with the application; and execute one or more of the plurality of containers associated with the application.

In one example embodiment of an apparatus, the processor is further to: continuously monitor for changes to the one or more local hardware resources that are available to the processor; detect a new local hardware resource that has been added to the one or more local hardware resources that are available to the processor; and add the new local hardware resource to the pool of shared hardware resources.

In one example embodiment of an apparatus, the processor to add the new local hardware resource to the pool of shared hardware resources is further to: execute a shared resource container for the new local hardware resource, wherein the shared resource container is to provide the cluster with access to the new local hardware resource.

In one example embodiment of an apparatus: the new local hardware resource comprises a USB device; and the shared resource container comprises a USB-over-IP service to provide the cluster with access to the USB device over the local network.

In one example embodiment of an apparatus: the new local hardware resource comprises a display device; and the shared resource container comprises a service to display video output from another computing node of the cluster on the display device.

In one example embodiment of an apparatus, the processor to execute one or more of the plurality of containers associated with the application is further to: orchestrate execution of the plurality of containers across the cluster of computing nodes; execute a first subset of the plurality of containers; and schedule one or more second subsets of the plurality of containers for execution on one or more other computing nodes of the cluster.

In one example embodiment of an apparatus, the processor is further to: determine that a particular computing node of the cluster has failed; and re-orchestrate execution of the plurality of containers across the cluster, wherein one or more containers previously executing on the particular computing node are to be executed on one or more remaining nodes of the cluster.

In one example embodiment of an apparatus, the processor to join the cluster of computing nodes is further to obtain cluster configuration parameters from one or more of the plurality of computing nodes.

In one example embodiment of an apparatus, the processor to detect the plurality of computing nodes on the local network is further to send a multicast DNS packet over the local network to discover the plurality of computing nodes.

In one example embodiment of an apparatus, the plurality of computing nodes comprise one or more physical machines and one or more virtual machines.

One or more embodiments may include a system, comprising: a router to enable communication over a local network; and a plurality of computing nodes, wherein the plurality of computing nodes comprise a plurality of heterogeneous edge processing devices, and wherein the plurality of computing nodes are collectively to: connect to the local network via the router; detect the plurality of computing nodes on the local network; join a cluster of computing nodes, wherein the cluster of computing nodes comprises the plurality of computing nodes on the local network; configure a shared file system associated with the cluster, wherein the shared file system is locally mirrored on each of the plurality of computing nodes of the cluster, and wherein data written to the shared file system is replicated across each of the plurality of computing nodes of the cluster in real time; configure a pool of shared hardware resources associated with the cluster, wherein the pool of shared hardware resources comprises a plurality of local hardware resources of the plurality of computing nodes in the cluster, and wherein the pool of shared hardware resources is shared across the cluster; provision the plurality of computing nodes with a plurality of container images for an application configured to execute on the cluster, wherein the plurality of container images are for executing a plurality of containers associated with the application; and orchestrate execution of the plurality of containers across the cluster of computing nodes.

In one example embodiment of a system, the system further comprises an edge provisioning node to provision the plurality of computing nodes with a software stack for creating a zero-configuration cluster.

In one example embodiment of a system, the plurality of computing nodes are further to: continuously monitor for changes to the plurality of local hardware resources of the plurality of computing nodes; detect a new local hardware resource that has been added to a particular computing node of the plurality of computing nodes; and add the new local hardware resource to the pool of shared hardware resources.

In one example embodiment of a system, the plurality of computing nodes to add the new local hardware resource to the pool of shared hardware resources are further to: execute a shared resource container for the new local hardware resource, wherein the shared resource container is to provide the cluster with access to the new local hardware resource.

In one example embodiment of a system, the plurality of computing nodes are further to: determine that a particular computing node of the cluster has failed; and re-orchestrate execution of the plurality of containers across the cluster, wherein one or more containers previously executing on the particular computing node are to be executed on one or more remaining nodes of the cluster.

One or more embodiments may include at least one machine accessible storage medium having instructions stored thereon, wherein the instructions, when executed on a machine, cause the machine to: connect to a local network via a network interface; detect a plurality of computing nodes on the local network, wherein the plurality of computing nodes comprise a plurality of heterogeneous edge processing devices; join a cluster of computing nodes, wherein the cluster of computing nodes comprises the plurality of computing nodes on the local network; configure a storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time; configure one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster; obtain a plurality of container images for an application configured to execute on the cluster, wherein the plurality of container images are for executing a plurality of containers associated with the application; and orchestrate execution of the plurality of containers across the cluster of computing nodes.

In one example embodiment of a storage medium, the instructions further cause the machine to: continuously monitor for changes to the one or more local hardware resources that are available to a processor; detect a new local hardware resource that has been added to the one or more local hardware resources that are available to the processor; and add the new local hardware resource to the pool of shared hardware resources.

In one example embodiment of a storage medium, the instructions that cause the machine to add the new local hardware resource to the pool of shared hardware resources further cause the machine to: execute a shared resource container for the new local hardware resource, wherein the shared resource container is to provide the cluster with access to the new local hardware resource.

In one example embodiment of a storage medium: the new local hardware resource comprises a USB device; and the shared resource container comprises a USB-over-IP service to provide the cluster with access to the USB device over the local network.

In one example embodiment of a storage medium: the new local hardware resource comprises a display device; and the shared resource container comprises a service to display video output from another computing node of the cluster on the display device.

In one example embodiment of a storage medium, the instructions further cause the machine to: determine that a particular computing node of the cluster has failed; and re-orchestrate execution of the plurality of containers across the cluster, wherein one or more containers previously executing on the particular computing node are to be executed on one or more remaining nodes of the cluster.

One or more embodiments may include a method, comprising: connecting to a local network via a network interface; detecting a plurality of computing nodes on the local network, wherein the plurality of computing nodes comprise a plurality of heterogeneous edge processing devices; joining a cluster of computing nodes, wherein the cluster of computing nodes comprises the plurality of computing nodes on the local network; configuring a storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time; configuring one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster; obtaining a plurality of container images for an application configured to execute on the cluster, wherein the plurality of container images are for executing a plurality of containers associated with the application; and orchestrating execution of the plurality of containers across the cluster of computing nodes.

In one example embodiment of a method, the method further comprises: continuously monitoring for changes to the one or more local hardware resources that are available; detecting a new local hardware resource that has been added to the one or more local hardware resources; and adding the new local hardware resource to the pool of shared hardware resources.

In one example embodiment of a method, adding the new local hardware resource to the pool of shared hardware resources comprises: executing a shared resource container for the new local hardware resource, wherein the shared resource container is to provide the cluster with access to the new local hardware resource.

In one example embodiment of a method, the method further comprises: determining that a particular computing node of the cluster has failed; and re-orchestrating execution of the plurality of containers across the cluster, wherein one or more containers previously executing on the particular computing node are to be executed on one or more remaining nodes of the cluster.

What is claimed is:

1. An apparatus, comprising:
a network interface to communicate over a local network;
a storage drive; and
a processor to:
connect to the local network via the network interface;
detect a plurality of computing nodes on the local network, wherein the plurality of computing nodes comprise a plurality of heterogeneous edge processing devices;
join a cluster of computing nodes, wherein the cluster of computing nodes comprises the plurality of computing nodes on the local network;
configure the storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time;
configure one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster;
obtain a plurality of container images for an application configured to execute on the cluster, wherein the plurality of container images are for executing a plurality of containers associated with the application; and
execute one or more of the plurality of containers associated with the application.

2. The apparatus of claim 1, wherein the processor is further to:
continuously monitor for changes to the one or more local hardware resources that are available to the processor;
detect a new local hardware resource that has been added to the one or more local hardware resources that are available to the processor; and
add the new local hardware resource to the pool of shared hardware resources.

3. The apparatus of claim 2, wherein the processor to add the new local hardware resource to the pool of shared hardware resources is further to:
execute a shared resource container for the new local hardware resource, wherein the shared resource container is to provide the cluster with access to the new local hardware resource.

4. The apparatus of claim 3, wherein:
the new local hardware resource comprises a USB device; and
the shared resource container comprises a USB-over-IP service to provide the cluster with access to the USB device over the local network.

5. The apparatus of claim 3, wherein:
the new local hardware resource comprises a display device; and
the shared resource container comprises a service to display video output from another computing node of the cluster on the display device.

6. The apparatus of claim 1, wherein the processor to execute one or more of the plurality of containers associated with the application is further to:
orchestrate execution of the plurality of containers across the cluster of computing nodes;
execute a first subset of the plurality of containers; and
schedule one or more second subsets of the plurality of containers for execution on one or more other computing nodes of the cluster.

7. The apparatus of claim 6, wherein the processor is further to:
determine that a particular computing node of the cluster has failed; and
re-orchestrate execution of the plurality of containers across the cluster, wherein one or more containers previously executing on the particular computing node are to be executed on one or more remaining nodes of the cluster.

8. The apparatus of claim 1, wherein the processor to join the cluster of computing nodes is further to obtain cluster configuration parameters from one or more of the plurality of computing nodes.

9. The apparatus of claim 1, wherein the processor to detect the plurality of computing nodes on the local network is further to send a multicast DNS packet over the local network to discover the plurality of computing nodes.

10. The apparatus of claim 1, wherein the plurality of computing nodes comprise one or more physical machines and one or more virtual machines.

11. A system, comprising:
a router to enable communication over a local network; and
a plurality of computing nodes, wherein the plurality of computing nodes comprise a plurality of heterogeneous edge processing devices, and wherein the plurality of computing nodes are collectively to:
connect to the local network via the router;
detect the plurality of computing nodes on the local network;
join a cluster of computing nodes, wherein the cluster of computing nodes comprises the plurality of computing nodes on the local network;
configure a shared file system associated with the cluster, wherein the shared file system is locally mirrored on each of the plurality of computing nodes of the cluster, and wherein data written to the shared file system is replicated across each of the plurality of computing nodes of the cluster in real time;
configure a pool of shared hardware resources associated with the cluster, wherein the pool of shared hardware resources comprises a plurality of local hardware resources of the plurality of computing nodes in the cluster, and wherein the pool of shared hardware resources is shared across the cluster;
provision the plurality of computing nodes with a plurality of container images for an application configured to execute on the cluster, wherein the plurality of container images are for executing a plurality of containers associated with the application; and
orchestrate execution of the plurality of containers across the cluster of computing nodes.

12. The system of claim 11, further comprising an edge provisioning node to provision the plurality of computing nodes with a software stack for creating a zero-configuration cluster.

13. The system of claim 11, wherein the plurality of computing nodes are further to:
continuously monitor for changes to the plurality of local hardware resources of the plurality of computing nodes;
detect a new local hardware resource that has been added to a particular computing node of the plurality of computing nodes; and
add the new local hardware resource to the pool of shared hardware resources.

14. The system of claim 13, wherein the plurality of computing nodes to add the new local hardware resource to the pool of shared hardware resources are further to:
execute a shared resource container for the new local hardware resource, wherein the shared resource container is to provide the cluster with access to the new local hardware resource.

15. The system of claim 11, wherein the plurality of computing nodes are further to:
determine that a particular computing node of the cluster has failed; and
re-orchestrate execution of the plurality of containers across the cluster, wherein one or more containers previously executing on the particular computing node are to be executed on one or more remaining nodes of the cluster.

16. At least one machine accessible storage medium having instructions stored thereon, wherein the instructions, when executed on a machine, cause the machine to:
connect to a local network via a network interface;
detect a plurality of computing nodes on the local network, wherein the plurality of computing nodes comprise a plurality of heterogeneous edge processing devices;
join a cluster of computing nodes, wherein the cluster of computing nodes comprises the plurality of computing nodes on the local network;
configure a storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time;
configure one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster;
obtain a plurality of container images for an application configured to execute on the cluster, wherein the plurality of container images are for executing a plurality of containers associated with the application; and
orchestrate execution of the plurality of containers across the cluster of computing nodes.

17. The storage medium of claim 16, wherein the instructions further cause the machine to:
continuously monitor for changes to the one or more local hardware resources that are available to a processor;
detect a new local hardware resource that has been added to the one or more local hardware resources that are available to the processor; and
add the new local hardware resource to the pool of shared hardware resources.

18. The storage medium of claim 17, wherein the instructions that cause the machine to add the new local hardware resource to the pool of shared hardware resources further cause the machine to:
execute a shared resource container for the new local hardware resource, wherein the shared resource container is to provide the cluster with access to the new local hardware resource.

19. The storage medium of claim 18, wherein:
the new local hardware resource comprises a USB device; and
the shared resource container comprises a USB-over-IP service to provide the cluster with access to the USB device over the local network.

20. The storage medium of claim 18, wherein:
the new local hardware resource comprises a display device; and
the shared resource container comprises a service to display video output from another computing node of the cluster on the display device.

21. The storage medium of claim 16, wherein the instructions further cause the machine to:
determine that a particular computing node of the cluster has failed; and
re-orchestrate execution of the plurality of containers across the cluster, wherein one or more containers previously executing on the particular computing node are to be executed on one or more remaining nodes of the cluster.

22. A method, comprising:
connecting to a local network via a network interface;
detecting a plurality of computing nodes on the local network, wherein the plurality of computing nodes comprise a plurality of heterogeneous edge processing devices;
joining a cluster of computing nodes, wherein the cluster of computing nodes comprises the plurality of computing nodes on the local network;
configuring a storage drive to join a shared file system associated with the cluster, wherein the storage drive is to provide local access to the shared file system, wherein the shared file system is locally mirrored on each of the plurality of computing nodes of the cluster, and wherein data written to the shared file system is replicated across each of the plurality of computing nodes of the cluster in real time;
configuring one or more local hardware resources to join a pool of shared hardware resources associated with the cluster, wherein the pool of shared hardware resources comprises a plurality of hardware resources of the plurality of computing nodes in the cluster, and wherein the pool of shared hardware resources is shared across the cluster;
obtaining a plurality of container images for an application configured to execute on the cluster, wherein the plurality of container images are for executing a plurality of containers associated with the application; and
orchestrating execution of the plurality of containers across the cluster of computing nodes.

23. The method of claim 22, further comprising:
continuously monitoring for changes to the one or more local hardware resources that are available;
detecting a new local hardware resource that has been added to the one or more local hardware resources; and
adding the new local hardware resource to the pool of shared hardware resources.

24. The method of claim 23, wherein adding the new local hardware resource to the pool of shared hardware resources comprises:
executing a shared resource container for the new local hardware resource, wherein the shared resource container is to provide the cluster with access to the new local hardware resource.

25. The method of claim 22, further comprising:
determining that a particular computing node of the cluster has failed; and
re-orchestrating execution of the plurality of containers across the cluster, wherein one or more containers previously executing on the particular computing node are to be executed on one or more remaining nodes of the cluster.
